(19) United States
(12) Patent Application Publication
(10) Pub. No.: US 2025/0337233 A1
(43) Pub. Date: Oct. 30, 2025

(54) METHODS, SYSTEMS, AND APPARATUS TO MONITOR POWER ELECTRONICS

(71) Applicant: Texas Instruments Incorporated, Dallas, TX (US)

(72) Inventors: Shailesh Ghotgalkar, Bengaluru (IN); Mihir Narendra Mody, Bengaluru (IN); Ashish Arvind Vanjari, Sugar Land, TX (US); Daniel Brad Wu, Plano, TX (US)

(21) Appl. No.: 18/758,620

(22) Filed: Jun. 28, 2024

Related U.S. Application Data
(60) Provisional application No. 63/638,495, filed on Apr. 25, 2024.
(60) Provisional application No. 63/638,985, filed on Apr. 26, 2024.

(51) Int. Cl. H02H 7/12; H02H 1/00

(52) U.S. Cl. CPC H02H 7/1203; H02H 1/0007

(57) ABSTRACT

An example system includes a component configured to generate a signal associated with a power electronics circuit. The system includes a hardware processor circuit coupled to the component, wherein the hardware processor circuit is configured to: measure, based on a configuration programmed by one or more programmable processor circuits, the signal over an amount of time to generate a first value, the configuration based on a model of the power electronics circuit; and based on a comparison between the first value and a second value satisfying at least one threshold, generate an interrupt associated with the power electronics circuit. Other examples are described.

### CROSS-REFERENCE TO RELATED APPLICATION

This patent application claims the benefit of and priority to U.S. Provisional Patent Application No. 63/638,495 filed Apr. 25, 2024, and U.S. Provisional Patent Application No. 63/638,985 filed Apr. 26, 2024, which applications are hereby incorporated herein by reference in their entireties.

### TECHNICAL FIELD

This description relates generally to signal analysis and, more particularly, to methods, systems, and apparatus to monitor power electronics.

### BACKGROUND

Power electronics is a field of electrical engineering utilizing semiconductor devices to control and convert electrical power. For example, a power electronics system includes a controller and a power electronics circuit. Power electronics circuits used to convert alternating current (AC) power to direct current (DC) power are referred to as rectifiers or AC-to-DC converters. Power electronics circuits used to convert DC power to AC power are referred to as inverters or DC-to-AC converters. Power electronics circuits used to convert DC power (e.g., at one voltage) to DC power (e.g., at another voltage level) are referred to as DC-to-DC converters. Power electronics circuits used to convert AC power (e.g., at one voltage) to AC power (e.g., at another voltage level) are referred to as AC-to-AC converters.

### SUMMARY

For methods, systems, and apparatus to monitor power electronics, an example system includes a component configured to generate a signal associated with a power electronics circuit. The system includes a hardware processor circuit coupled to the component, wherein the hardware processor circuit is configured to: measure, based on a configuration programmed by one or more programmable processor circuits, the signal over an amount of time to generate a first value, the configuration based on a model of the power electronics circuit; and based on a comparison between the first value and a second value satisfying at least one threshold, generate an interrupt associated with the power electronics circuit. Other examples are described.

For methods, systems, and apparatus to monitor power electronics, an example method includes measuring, based on a configuration programmed by one or more programmable processor circuits, a signal over an amount of time to generate a first value, the signal generated by a component associated with a power electronics circuit, the configuration based on a model of the power electronics circuit. The method includes, based on a comparison between the first value and a second value satisfying at least one threshold, generating an interrupt associated with the power electronics circuit. Other examples are described.

For methods, systems, and apparatus to monitor power electronics, an example system includes a component configured to generate a signal associated with a power electronics circuit. The system includes a hardware processor circuit coupled to the component, wherein the hardware processor circuit is configured to: measure, based on a configuration, the signal over an amount of time to generate a first value; and based on a comparison between the first value and a second value satisfying at least one threshold, generate an interrupt associated with the power electronics circuit. The system includes one or more programmable processor circuits coupled to the hardware processor circuit, wherein at least one of the one or more programmable processor circuits is configured to program the configuration for the hardware processor circuit based on a model of the power electronics circuit. Other examples are described.

### BRIEF DESCRIPTION OF THE DRAWINGS

FIG. 1 is a block diagram of a first example system to monitor power electronics for safety.

FIG. 2 is a block diagram of a second example system to monitor power electronics for safety.

FIG. 3 is a block diagram of an example system including an example system on a chip (SoC) to monitor power electronics for safety.

FIG. 4 is a block diagram of an example implementation of the waveform processor circuitry of FIG. 3.

FIG. 5 is a block diagram illustrating an example processing path for signals monitored by the waveform processor circuitry of FIG. 3.

FIG. 6A and FIG. 6B (collectively “FIG. 6”) are a flowchart representative of at least one of example machine-readable instructions or example operations that may be at least one of executed, instantiated, or performed using an example programmable circuitry implementation of at least one of the primary processor circuitry or the redundant processor circuitry of FIG. 3.

FIG. 7 is a flowchart representative of at least one of example machine-readable instructions or example operations that may be at least one of executed, instantiated, or performed using an example programmable circuitry implementation of the waveform processor circuitry of FIG. 3.

FIG. 8 is a block diagram of an example processing platform including programmable circuitry structured to execute, instantiate, or perform the example machine-readable instructions or perform the example operations of FIGS. 6 and 7 to implement at least one of the processor circuitry of FIG. 3 or the waveform processor circuitry of FIG. 4.

The drawings are not necessarily to scale. Generally, the same reference numbers in the drawing(s) and this description refer to the same or similar (in terms of at least one of functional or structural) at least one of features or parts. Although the drawings show regions with clean lines and boundaries, some or all of these lines and boundaries may be idealized. In reality, the boundaries or lines may be unobservable, blended or irregular.

### DETAILED DESCRIPTION

Power electronics circuits are used in a variety of applications such as AC power adapters, battery chargers, audio amplifiers, lighting systems, DC motor drives, renewable energy systems, and automative applications. For example, in electric vehicles (EVs) and hybrid electric vehicles (HEVs), DC-to-DC converters are used to charge batteries and DC-to-AC converters (e.g., inverters) are used to power propulsion systems (e.g., electric motors). Many controllers of power electronic circuits are integrated devices. For example, a controller of a power electronics circuit can be implemented as an integrated circuit (IC) referred to as a System on a Chip (SoC).

An SoC may include at least one of one or more central processor units (CPUs), one or more accelerators, or specialized hardware circuitry. As such, many SoCs include direct memory access (DMA) circuitry to regulate at least one of CPU, accelerator, or hardware circuitry access to memory. Also, SoCs are desirable for automated systems such as power electronics as a result of the ability to regulate various processes by controlling the passage of data between processor(s) and memory.

Power electronics systems may be subjected to one or more safety standards. For example, the Automotive Safety Integrity Level (ASIL) is a risk classification scheme defined by the International Organization for Standardization (ISO) 26262 standard. The ASIL scheme specifies functional safety for road vehicles and as such, power electronics systems in vehicles may be evaluated based on the ASIL scheme. The ASIL scheme includes four levels: ASIL A, ASIL B, ASIL C, and ASIL D. The ASIL D level specifies the highest level of safety measures in the ISO 26262 standard to avoid unreasonable residual risk.

To comply with safety standards (e.g., ASIL), power electronics systems monitor one or more signals associated with a power electronics circuit. Some power electronics systems utilize hardware redundancy to provide dynamic safety coverage. Hardware redundancy includes the use of a primary component to control a power electronics circuit and a redundant component that performs identical functions. In such systems, a controller of a power electronics circuit can compare signals output from the primary component to signals output from the redundant component to detect faults. Depending on the application type, the hardware that is duplicated can vary. For example, between industrial and automotive applications the scale and mode redundancy (e.g., sensor hardware, processor hardware, actuator hardware, etc.) could vary. By implementing hardware redundancy, a power electronics system can detect a fault before the fault causes a dangerous condition in the power electronics system.

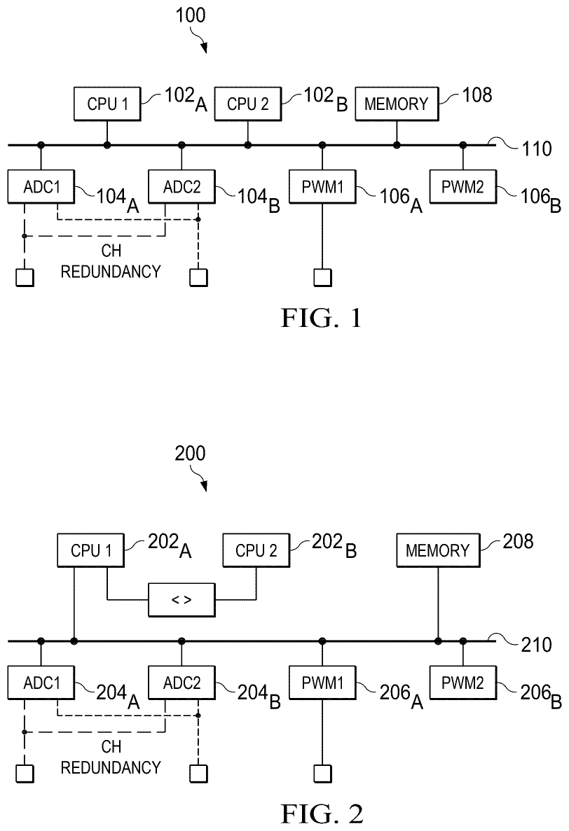

FIG. 1 is a block diagram of a first example system 100 to monitor power electronics for safety. In the example of FIG. 1, the system 100 includes primary components and redundant components. For example, the system 100 includes an example primary central processor unit (CPU) 102_{A}, an example primary analog-to-digital converter (ADC) 104_{A}, and an example primary pulse width modulation (PWM) actuator 106_{A}. The system 100 also includes an example redundant central processor unit (CPU) 102_{B}, an example redundant analog-to-digital converter (ADC) 104_{B}, and an example redundant pulse width modulation (PWM) actuator 106_{B}. In the example of FIG. 1, the primary components and redundant components are of the same type. For example, the primary components and the redundant components are manufactured by the same manufacture or utilize the same instruction set architecture (ISA). In the example of FIG. 1, the system 100 also includes example memory 108 and an example communication bus 110 by which at least one of the primary components or the redundant components can communicate.

In the illustrated example of FIG. 1, a technique known as lockstep can be used to monitor power electronics for safety. In the lockstep technique, a primary component and a redundant component run identical operations and the signals output from the primary component and the redundant component are compared. For example, lockstep comparison of the primary CPU 102_{A} and the redundant CPU 102_{B} includes hardware circuitry that samples the signals output from the primary CPU 102_{A} and the redundant CPU 102_{B} every clock cycle and compares the samples.

To perform lockstep comparison for the primary ADC 104_{A} and the redundant ADC 104_{B}, the channels (CHs) of the primary ADC 104_{A} and the redundant ADC 104_{B} are fed with the same input and at least one of the primary CPU 102_{A} or the redundant CPU 102_{B} compare the signals output from the primary ADC 104_{A} and the redundant ADC 104_{B}. To perform lockstep comparison for the primary PWM actuator 106_{A} and the redundant PWM actuator 106_{B}, the channels of the primary PWM actuator 106_{A} and the redundant PWM actuator 106_{B} are replicated and one or more of hardware circuitry or at least one of the primary CPU 102_{A} or the redundant CPU 102_{B} compare the channels to determine if there is one-to-one overlap between the channels.

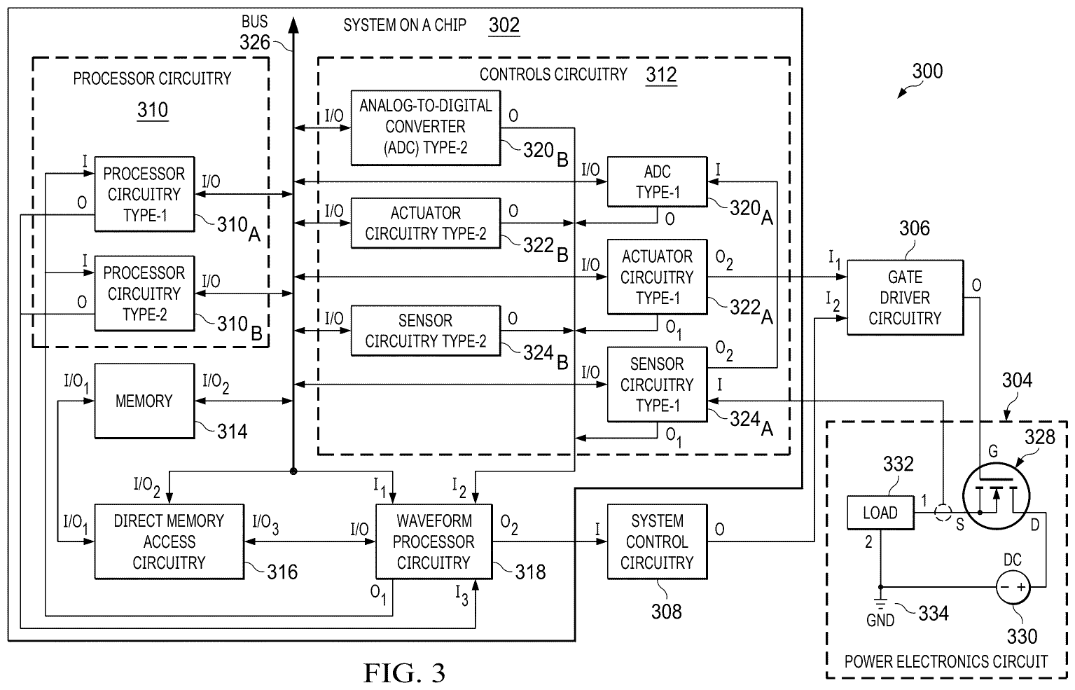

FIG. 2 is a block diagram of a second example system 200 to monitor power electronics for safety. In the example of FIG. 2, the system 200 includes primary components and redundant components. For example, the system 200 includes an example primary central processor unit (CPU) 202_{A}, an example primary analog-to-digital converter (ADC) 204_{A}, and an example primary pulse width modulation (PWM) actuator 206_{A}. The system 200 also includes an example redundant central processor unit (CPU) 202_{B}, an example redundant analog-to-digital converter (ADC) 204_{B}, and an example redundant pulse width modulation (PWM) actuator 206_{B}. In the example of FIG. 2, the primary components and redundant components are of the same type. For example, the primary components and the redundant components are manufactured by the same manufacture or utilize the same ISA. In the example of FIG. 2, the system 200 also includes example memory 208 and an example communication bus 210 by which at least one of the primary components or the redundant components can communicate.

In the illustrated example of FIG. 2, a technique known as reciprocal comparison can be used to monitor power electronics for safety if the system 200 is not structured for lockstep comparison. In the reciprocal comparison technique, the primary components and the redundant components run the same operation, the primary CPU 202_{A} and the redundant CPU 202_{B} compute the control loop response individually, and at least one of the primary CPU 202_{A} and the redundant CPU 202_{B} periodically compare the control loop responses at set intervals (e.g., after a set number of clock cycles).

FIGS. 1 and 2 illustrate two techniques (e.g., lockstep comparison and reciprocal comparison) for monitoring power electronics for safety. These techniques have relatively simple layouts and are suitable for devices that are subject to lower safety levels such as ASIL A and ASIL B. However, the techniques of FIGS. 1 and 2 utilize a large number of million instructions per second (MIPS) to compare signals (e.g., at every clock cycle). Also, by utilizing the same type of component for the primary components and the redundant components, the techniques of FIGS. 1 and 2 do not include diversity and therefore may not detect common cause faults (CCFs). For example, because the primary components and the redundant components utilize the same type of hardware or the same type of ISA, signals generated by the primary components and the redundant components will be almost identical. As such, if the same fault is present in a primary component and a redundant component, the two components may continue to produce almost identical signals which would prohibit the detection of the fault.

Also, by utilizing the same type of components for the primary components and the redundant components, the techniques of FIGS. 1 and 2 increase at least one of the monetary cost or area consumption on an IC. For example, utilizing the same type of component might be more monetarily expensive than utilizing diverse components offered at different price points. Also, utilizing the same type of component might consume more area on an IC than utilizing diverse components that vary in size.

Furthermore, the techniques of FIGS. 1 and 2 are overly strict in their comparison. For example, in real-time control systems, latencies in the system, memory, and data paths lead to slight variations in signals output by primary components and redundant components while the signals remain functionally the same (e.g., the primary components and the redundant components do not have a fault). However, because of the slight variations in the signals, the techniques of FIGS. 1 and 2 may detect a false positive fault. Therefore, utilizing the techniques of FIGS. 1 and 2 to perform monitoring in real-time control systems is difficult due to such strict comparison.

Examples described herein include methods, systems, and apparatus to monitor power electronics. For example, described examples include heterogeneous comparison of primary components and redundant components with diverse CPUs, algorithms, and peripherals evaluated for high-level function. Examples described herein perform comparison of signals generated by primary components and redundant components at FTT intervals without false positives despite large variation that may result from diverse components.

Examples described herein include robust, adaptable reciprocal comparison. For example, described examples compare signals output from primary components and redundant components with a wider margin of variability (e.g., than the techniques of FIGS. 1 and 2). As such, examples described herein allow divergent systems to perform the same task and remain within a threshold range without issuing a false positive fault detection. Also, described examples are adaptable and the signals monitored in a power electronics circuit can be adjusted (e.g., selected) based on at least one of the type of power electronics circuit or type of control mode used to control the power electronics circuit. Examples described herein also reduce at least one of the monetary cost or area consumption to implement a power electronics monitoring system. For example, described examples provide between 20% and 30% cost savings compared to the techniques of FIGS. 1 and 2.

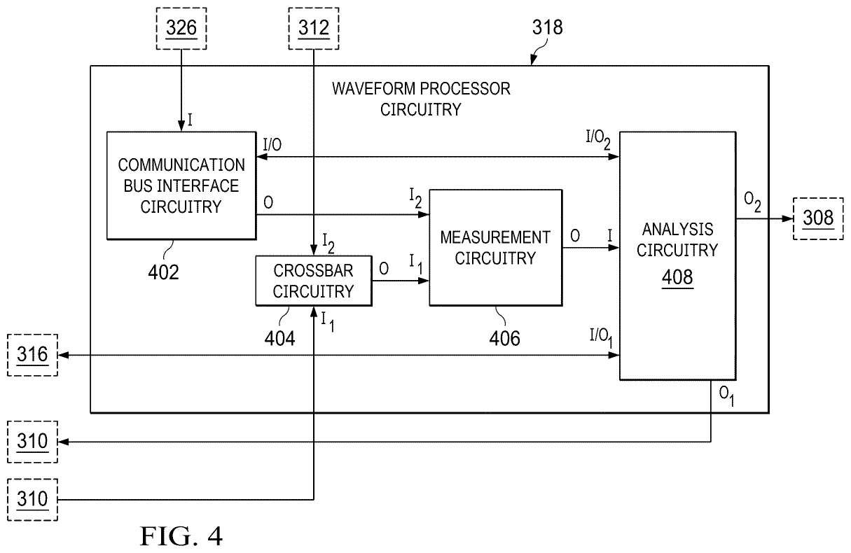

FIG. 3 is a block diagram of an example system 300 including an example system on a chip (SoC) 302 to monitor power electronics for safety. In the example of FIG. 3, the system 300 includes an example power electronics circuit 304, example gate driver circuitry 306, and example system control circuitry 308. Also, in the example of FIG. 3, the SoC 302 includes example processor circuitry 310, example controls circuitry 312, example memory 314, example direct memory access (DMA) circuitry 316, and example waveform processor circuitry 318. In the example of FIG. 3, the processor circuitry 310 and the controls circuitry 312 include primary components and redundant components. For example, the processor circuitry 310 includes example primary processor circuitry 310_{A} and example redundant processor circuitry 310_{B} (e.g., one or more programmable processor circuits). Also, for example, the controls circuitry 312 includes an example primary analog-to-digital converter (ADC) 320_{A}, an example redundant ADC 320_{B}, example primary actuator circuitry 322_{A}, example redundant actuator circuitry 322_{B}, example primary sensor circuitry 324_{A}, and example redundant sensor circuitry 324_{B}.

In the illustrated example of FIG. 3, the primary components and redundant components are of different types. For example, the primary components and the redundant components are manufactured by different manufactures or utilize different ISAs. In the example of FIG. 3, the primary processor circuitry 310_{A} is of a first type and the redundant processor circuitry 310_{B} is of a second type. Also, the primary ADC 320_{A} is of a first type and the redundant ADC 320_{B} is of a second type. In the example of FIG. 3, the primary actuator circuitry 322_{A} is of a first type and the redundant actuator circuitry 322_{B} is of a second type. Also, the primary sensor circuitry 324_{A} is of a first type and the redundant sensor circuitry 324_{B} is of a second type.

In the illustrated example of FIG. 3, the SoC 302 includes an example communication bus 326 to facilitate communication as described below. In the example of FIG. 3, the power electronics circuit 304 includes an example switch 328, an example power source 330, an example load 332, and an example ground terminal 334. Also, the gate driver circuitry 306 has a first input terminal, a second input terminal, and an output terminal. In the example of FIG. 3, the system control circuitry 308 has an input terminal and an output terminal.

In the illustrated example of FIG. 3, each of the primary processor circuitry 310_{A} and the redundant processor circuitry 310_{B} has an input terminal, an output terminal, and an input/output (I/O) terminal. In the example of FIG. 3, the memory 314 has a first I/O terminal and a second I/O terminal. Also, the DMA circuitry 316 has a first I/O terminal, a second I/O terminal, and a third I/O terminal. In the example of FIG. 3, the waveform processor circuitry 318 has a first input terminal, a second input terminal, a third input terminal, a first output terminal, a second output terminal, and an I/O terminal.

As described above, primary components are used to control a power electronics circuit (e.g., the power electronics circuit 304) and redundant components perform identical functions for purposes of monitoring a signal. As such, the primary components of the controls circuitry 312 are illustrated with a different amount of terminals than the redundant components of the controls circuitry 312. In some examples, the primary components and the redundant components of the controls circuitry 312 have the same number of terminals. In the example of FIG. 3, the primary ADC 320_{A} has an input terminal, an output terminal, and an I/O terminal. Also, the primary actuator circuitry 322_{A} has a first output terminal, a second output terminal, and an I/O terminal. In the example of FIG. 3, the primary sensor circuitry 324_{A} has an input terminal, a first output terminal, a second output terminal, and an I/O terminal.

In the illustrated example of FIG. 3, each of the redundant ADC 320_{B}, the redundant actuator circuitry 322_{B}, and the redundant sensor circuitry 320_{B} has an output terminal and an I/O terminal. Also, the switch 328 has a gate terminal, a drain terminal, and a source terminal. In the example of FIG. 3, the power source 330 has a positive terminal and a negative terminal. Also, the load 332 has a first terminal and a second terminal. In the example of FIG. 3, one or more of the components of FIG. 3 may include one or more terminals than those illustrated in FIG. 3. For example, each terminal illustrated in FIG. 3 may, in reality, be implemented by more than one terminal.

In the illustrated example of FIG. 3, the gate driver circuitry 306 is implemented by at least one of analog circuitry or digital circuitry. In the example of FIG. 3, the first input terminal of the gate driver circuitry 306 is coupled to the second output terminal of the primary actuator circuitry 322_{A}, the second input terminal of the gate driver circuitry 306 is coupled to the output terminal of the system control circuitry 308, and the output terminal of the gate driver circuitry 306 is coupled to the gate terminal of the switch 328. In the example of FIG. 3, the system control circuitry 308 is implemented by at least one of analog circuitry or digital circuitry. Also, the input terminal of the system control circuitry 308 is coupled to the second output terminal of the waveform processor circuitry 318 and the output terminal of the system control circuitry 308 is coupled to the second input terminal of the gate driver circuitry 306.

In the illustrated example of FIG. 3, the primary processor circuitry 310_{A} is implemented by at least one of analog circuitry or digital circuitry. In the example of FIG. 3, the input terminal of the primary processor circuitry 310_{A} is coupled to the first output terminal of the waveform processor circuitry 318, the output terminal of the primary processor circuitry 310_{A} is coupled to the third input terminal of the waveform processor circuitry 318, and the I/O terminal of the primary processor circuitry 310_{A} is coupled to the communication bus 326. Also, the redundant processor circuitry 310_{B} is implemented by at least one of analog circuitry or digital circuitry. In the example of FIG. 3, the input terminal of the redundant processor circuitry 310_{B} is coupled to the first output terminal of the waveform processor circuitry 318, the output terminal of the redundant processor circuitry 310_{B} is coupled to the third input terminal of the waveform processor circuitry 318, and the I/O terminal of the redundant processor circuitry 310_{B} is coupled to the communication bus 326.

In the illustrated example of FIG. 3, the memory 314 is implemented by static random-access memory (SRAM). Also or alternatively, the memory 314 is implemented by Synchronous Dynamic Random Access Memory (SDRAM), Dynamic Random Access Memory (DRAM), RAMBUS® Dynamic Random Access Memory (RDRAM®), or any other type of RAM device. In some examples, the memory 314 is implemented by one or a combination of flash memory or any other desired type of memory device. In the example of FIG. 3, the first I/O terminal of the memory 314 is coupled to the first I/O terminal of the DMA circuitry 316 and the second I/O terminal of the memory 314 is coupled to the communication bus 326.

In the illustrated example of FIG. 3, the DMA circuitry 316 is implemented by at least one of analog circuitry or digital circuitry. In the example of FIG. 3, the first I/O terminal of the DMA circuitry 316 is coupled to the first I/O terminal of the memory 314, the second I/O terminal of the DMA circuitry 316 is coupled to the communication bus 326, and the third I/O terminal of the DMA circuitry 316 is coupled to the I/O terminal of the waveform processor circuitry 318. In the example of FIG. 3, the waveform processor circuitry 318 is implemented by at least one of analog circuitry or digital circuitry. For example, the waveform processor circuitry 318 is implemented by hardware circuitry that is specifically structured to perform example operations described herein. As such, the waveform processor circuitry 318 is implemented by or implements a hardware processor circuit. Also, the first input terminal of the waveform processor circuitry 318 is coupled to the communication bus 326.

In the illustrated example of FIG. 3, the second input terminal of the waveform processor circuitry 318 is coupled to the output terminal of the primary ADC 320_{A}, the output terminal of the redundant ADC 320_{B}, the first output terminal of the primary actuator circuitry 322_{A}, the output terminal of the redundant actuator circuitry 322_{B}, the first output terminal of the primary sensor circuitry 324_{A}, and the output terminal of the redundant sensor circuitry 324_{B}. In the example of FIG. 3, the third input terminal of the waveform processor circuitry 318 is coupled to the output terminal of the primary processor circuitry 310_{A} and the output terminal of the redundant processor circuitry 310_{B}. The connections between the waveform processor circuit 318 and the processor circuitry 310 may have a relatively short trave length in order to reduce the latency within the system 300, as compared to other systems. Also, the first output terminal of the waveform processor circuitry 318 is coupled to the input terminal of the primary processor circuitry 310_{A} and the input terminal of the redundant processor circuitry 310_{B}. In the example of FIG. 3, the second output terminal of the waveform processor circuitry 318 is coupled to the input terminal of the system control circuitry 308. Also, the I/O terminal of the waveform processor circuitry 318 is coupled to the third I/O terminal of the DMA circuitry 316.

In the illustrated example of FIG. 3, the primary ADC 320_{A} is implemented by at least one of analog circuitry or digital circuitry. In the example of FIG. 3, the input terminal of the primary ADC 320_{A} is coupled to the second output terminal of the primary sensor circuitry 324_{A}, the output terminal of the primary ADC 320_{A} is coupled to the second input terminal of the waveform processor circuitry 318, and the I/O terminal of the primary ADC 320_{A} is coupled to the communication bus 326. In the example of FIG. 3, the redundant ADC 320_{B} is implemented by at least one of analog circuitry or digital circuitry. Also, the output terminal of the redundant ADC 320_{B} is coupled to the second input terminal of the waveform processor circuitry 318 and the I/O terminal of the redundant ADC 320_{B} is coupled to the communication bus 326.

In the illustrated example of FIG. 3, the primary actuator circuitry 322_{A} is implemented by at least one of analog circuitry or digital circuitry. For example, the primary actuator circuitry 322_{A} implements a PWM actuator. In the example of FIG. 3, the first output terminal of the primary actuator circuitry 322_{A} is coupled to the second input terminal of the waveform processor circuitry 318, the second output terminal of the primary actuator circuitry 322_{A} is coupled to the first input terminal of the gate driver circuitry 306, and the I/O terminal of the primary actuator circuitry 322_{A} is coupled to the communication bus 326. Also, the redundant actuator circuitry 322_{B} is implemented by at least one of analog circuitry or digital circuitry. For example, the redundant actuator circuitry 322_{B} implements a PWM actuator. In the example of FIG. 3, the output terminal of the redundant actuator circuitry 322_{B} is coupled to the second input terminal of the waveform processor circuitry 318 and the I/O terminal of the redundant actuator circuitry 322_{B} is coupled to the communication bus 326.

In the illustrated example of FIG. 3, the primary sensor circuitry 324_{A} is implemented by at least one of analog circuitry or digital circuitry. For example, the primary sensor circuitry 324_{A} implements a timing monitor (e.g., a component to monitor the speed of a rotating machine, the time between pulses, the period and duty cycle of a pulse train, etc.). Also or alternatively, the primary sensor circuitry 324_{A} implements a sigma-delta filter or a motor control sensor (e.g., a component to monitor a rotating machine). In the example of FIG. 3, the input terminal of the primary sensor circuitry 324_{A} receives feedback from the power electronics circuit 304, the first output terminal of the primary sensor circuitry 324_{A} is coupled to the second input terminal of the waveform processor circuitry 318, the second output terminal of the primary sensor circuitry 324_{A} is coupled to the input terminal of the primary ADC 320_{A}, and the I/O terminal of the primary sensor circuitry 324_{A} is coupled to the communication bus 326.

In the illustrated example of FIG. 3, the redundant sensor circuitry 324_{B} is implemented by at least one of analog circuitry or digital circuitry. For example, the redundant sensor circuitry 324_{B} implements a timing monitor (e.g., a component to monitor the speed of a rotating machine, the time between pulses, the period and duty cycle of a pulse train, etc.). Also or alternatively, the redundant sensor circuitry 324_{B} implements a sigma-delta filter or a motor control sensor (e.g., a component to monitor a rotating machine). In the example of FIG. 3, the output terminal of the redundant sensor circuitry 324_{B} is coupled to the second input terminal of the waveform processor circuitry 318 and the I/O terminal of the redundant sensor circuitry 324_{B} is coupled to the communication bus 326.

In the illustrated example of FIG. 3, any of the primary processor circuitry 310_{A}, the redundant processor circuitry 310_{B}, the memory 314, the DMA circuitry 316, the waveform processor circuitry 318, the primary ADC 320_{A}, the redundant ADC 320_{B}, the primary actuator circuitry 322_{A}, the redundant actuator circuitry 322_{B}, the primary sensor circuitry 324_{A}, and the redundant sensor circuitry 324_{B} can communicate via the communication bus 326. In examples described herein, the communication bus 326 may be implemented using at least one of any suitable wired or any suitable wireless communication. Also or alternatively, the communication bus 326 includes at least one of software, machine readable instructions, or communication protocols by which information is communicated among at least one of the primary processor circuitry 310_{A}, the redundant processor circuitry 310_{B}, the memory 314, the DMA circuitry 316, the waveform processor circuitry 318, the primary ADC 320_{A}, the redundant ADC 320_{B}, the primary actuator circuitry 322_{A}, the redundant actuator circuitry 322_{B}, the primary sensor circuitry 324_{A}, or the redundant sensor circuitry 324_{B}.

In the illustrated example of FIG. 3, the switch 328 is implemented by an n-channel metal-oxide semiconductor field-effect transistor (MOSFET). Alternatively, the switch 328 may be implemented by an n-channel field-effect transistor (FET), an n-channel insulated-gate bipolar transistor (IGBT), an n-channel junction field effect transistor (JFET), a negative-positive-negative (NPN) bipolar junction transistor (BJT) or, with slight modifications, a p-type equivalent device. In the example of FIG. 3, the switch 328 may be a depletion mode device, a drain-extended device, an enhancement mode device, a natural transistor, or other type of device structure transistor. Furthermore, the switch 328 may be implemented at least one of in or over a silicon (Si) substrate, a silicon carbide (SiC) substrate, a gallium nitride (GaN) substrate, or a gallium arsenide (GaAs) substrate.

In the illustrated example of FIG. 3, the gate terminal of the switch 328 is coupled to the output terminal of the gate driver circuitry 306, the drain terminal of the switch 328 is coupled to the positive terminal of the power source 330, and the source terminal of the switch 328 is coupled to the first terminal of the load 332. In the example of FIG. 3, the power source 330 is implemented by one or more batteries. Example batteries include lithium-ion batteries, nickel-cadmium batteries, nickel-metal hydride batteries, and lead-acid batteries. In some examples, the power source 330 is implemented by one or more ultracapacitors. In some examples, the power source 330 is implemented by an AC-to-DC power converter (e.g., an AC-to-DC converter, a rectifier, etc.). In the example of FIG. 3, the positive terminal of the power source 330 is coupled to the drain terminal of the switch 328 and the negative terminal of the power source 330 is coupled to the second terminal of the load 332 and the ground terminal 334.

In the illustrated example of FIG. 3, the load 332 is an electrical load such as a resistive load, an inductive load, or a capacitive load. Example resistive loads include household appliances such as incandescent lights, toasters, ovens, space heaters, and coffee makers among others. Example inductive loads include motors, solenoids, contactor coils, compressors, speakers, relays, transformers, inductors, and power generators, among others. Example capacitive loads include capacitor banks, cables, and batteries, among others. In the example of FIG. 3, the first terminal of the load 332 is coupled to the source terminal of the switch 328 and the second terminal of the load 332 is coupled to the negative terminal of the power source 330 and the ground terminal 334.

In the illustrated example of FIG. 3, the ground terminal 334 is a common terminal to which electrical components of the system 300 are coupled. In the example of FIG. 3, the ground terminal 334 may or may not be coupled to the Earth. For example, when the system 300 is implemented in an automotive application (e.g., an EV or an HEV application), the ground terminal 334 may be the chassis of a vehicle where the chassis is not coupled to the Earth. Also or alternatively, when the system 300 is implemented in a non-automotive application, the ground terminal 334 may be the chassis of an electrical system where the chassis is coupled to the Earth. In the example of FIG. 3, the ground terminal 334 is coupled to the negative terminal of the power source 330 and the second terminal of the load 332.

In the illustrated example of FIG. 3, the processor circuitry 310 (e.g., at least one of the primary processor circuitry 310_{A} or the redundant processor circuitry 310_{B}) configures the controls circuitry 312 to operate as a controller for the power electronics circuit 304. In the example of FIG. 3, depending on the topology of the power electronics circuit 304, the configuration of the controls circuitry 312 may vary. For example, the power electronics circuit 304 may be a phase shifted full bridge (e.g., a type of DC-to-DC converter), an inductor, inductor, capacitor (LLC) converter (e.g., a type of DC-to-DC converter), a resonant capacitor, inductor, inductor, capacitor (CLLC) converter (e.g., a type of DC-to-DC converter), a dual active bridge (e.g., a type of DC-to-DC converter), an AC-to-DC converter, a DC-to-AC converter, or any other type of power converter. Also or alternatively, the power electronics circuit 304 may have another topology.

In the illustrated example of FIG. 3, depending on the topology of the power electronics circuit 304, the type of control mode that the controls circuitry 312 utilizes to control the power electronics circuit 304 may vary. For example, when the power electronics circuit 304 implements a phase shifted full bridge, the processor circuitry 310 configures the controls circuitry 312 to utilize peak current mode control (PCMC) or average current mode control (ACMC) to control the power electronics circuit 304. Also, for example, when the power electronics circuit 304 implements an LLC converter, the processor circuitry 310 configures the controls circuitry 312 to utilize hybrid hysteretic control (HHC) or clamped frequency control to control the power electronics circuit 304.

In the illustrated example of FIG. 3, when the power electronics circuit 304 implements a resonant CLLC converter, the processor circuitry 310 configures the controls circuitry 312 to transition between high and low quality factor (Q) in the power electronics circuit 304 for dominant, parallel, or series resonant action. Also, for example, when the power electronics circuit 304 implements a dual active bridge, the processor circuitry 310 configures the controls circuitry 312 to utilize single phase switching (SPS), double phase switching (DPS), extended phase switching (EPS), or triple phase switching (TPS) to control the power electronics circuit 304. Also or alternatively, control modes for the power electronics circuit 304 may vary for other topologies. In some examples, other control modes may be possible for phase shifted full bridges, LLC converters, resonant CLLC converters, and dual active bridges.

As described above, the processor circuitry 310 configures the controls circuitry 312 to operate as a controller for the power electronics circuit 304 based on at least one of the topology of the power electronics circuit 304 or the type of control mode utilized to control the power electronics circuit 304. In the example of FIG. 3, the processor circuitry 310 programs at least one setting of the controls circuitry 312 for the power electronics circuit 304 to implement a controller. For example, the processor circuitry 310 maintains a model of the power electronics circuit 304. In the example of FIG. 3, the processor circuitry 310 programs at least one setting of the controls circuitry 312 to implement a controller based on the model of the power electronics circuit 304.

In the illustrated example of FIG. 3, the model for the power electronics circuit 304 is based on at least one of the topology of the power electronics circuit 304 or the control mode for the power electronics circuit 304. In the example of FIG. 3, the model for the power electronics circuit 304 includes one or more equations defining at least one of voltage, current, power, quality factor, efficiency, or another parameter of the power electronics circuit 304. Also or alternatively, the model for the power electronics circuit 304 includes one or more equations defining how to generate one or more control signals for the power electronics circuit 304. In this manner, the model of the power electronics circuit 304 allows the processor circuitry 310 to determine (e.g., predict) a target state for (e.g., an expected state of) the power electronics circuit 304 based on a candidate input value.

For the implementation of the power electronics circuit 304 illustrated in FIG. 3, the primary processor circuitry 310_{A} sends a control signal to the primary actuator circuitry 322_{A} via the communication bus 326. Based on the control signal, the primary actuator circuitry 322_{A} sends a drive signal to the gate driver circuitry 306. Based on the drive signal, the gate driver circuitry 306 drives the gate terminal of the switch 328. The primary sensor circuitry 324_{A} monitors the power electronics circuit 304. For example, the primary sensor circuitry 324_{A} monitors the current flowing through the switch 328. Based on monitoring the power electronics circuit 304, the primary sensor circuitry 324_{A} provides a measurement to the primary ADC 320_{A} which converts the measurement from the analog domain to the digital domain. In the example of FIG. 3, the primary ADC 320_{A} communicates the digital domain measurement to the primary processor circuitry 310_{A} via the communication bus 326. As such, the primary processor circuitry 310_{A} can update a subsequent control signal associated with the power electronics circuit 304.

As described above, the redundant components of the processor circuitry 310 and the controls circuitry 312 perform identical functions as the primary components of the processor circuitry 310 and the controls circuitry 312. However, the redundant components may not have identical hardware (e.g., the redundant components may be produced by different manufacturers) in order to reduce the likelihood of two redundant components suffering the same fault. As such, the operation of the power electronics circuit 304 or the controller thereof can be monitored. For example, the SoC 302 includes the waveform processor circuitry 318 to monitor one or more signals associated with the power electronics circuit 304. As such, the waveform processor circuitry 318 provides improved safety by monitoring the one or more signals associated with the power electronics circuit 304.

In the illustrated example of FIG. 3, the waveform processor circuitry 318 includes crossbar circuitry to facilitate monitoring of at least one of the primary processor circuitry 310_{A}, the redundant processor circuitry 310_{B}, the primary ADC 320_{A}, the redundant ADC 320_{B}, the primary actuator circuitry 322_{A}, the redundant actuator circuitry 322_{B}, the primary sensor circuitry 324_{A}, or the redundant sensor circuitry 324_{B}. Also or alternatively, one or more components (e.g., primary components or redundant components) external to the SoC 302 may be coupled to the crossbar circuitry of the waveform processor circuitry 318. In the example of FIG. 3, the processor circuitry 310 sets a configuration for the waveform processor circuitry 318 based on the model for the power electronics circuit 304. For example, the processor circuitry 310 sets a configuration for the waveform processor circuitry 318 via the communication bus 326. In some examples, the processor circuitry 310 sets the configuration for the waveform processor circuitry 318 in the memory 314 and the waveform processor circuitry 318 utilizes the DMA circuitry 316 to access the configuration from the memory 314.

As described above, the model for the power electronics circuit 304 is based on at least one of the topology of the power electronics circuit 304 or the control mode for the power electronics circuit 304. As such, the processor circuitry 310 sets the configuration for the waveform processor circuitry 318 to enable heterogenous reciprocal comparison based on various topologies and control modes possible for the power electronics circuit 304. In the example of FIG. 3, after setting the configuration for the waveform processor circuitry 318, the processor circuitry 310 sends a trigger (e.g., a trigger event) to the waveform processor circuitry 318 to cause the waveform processor circuitry 318 to monitor at least one signal associated with the power electronics circuit 304. In the example of FIG. 3, the waveform processor circuitry 318 accesses the configuration. For example, the waveform processor circuitry 318 accesses the configuration from the processor circuitry 310 via the communication bus 326. Also or alternatively, the waveform processor circuitry 318 accesses the configuration from the memory 314 via the DMA circuitry 316.

In the illustrated example of FIG. 3, based on the configuration, the waveform processor circuitry 318 selects at least one signal associated with the power electronics circuit 304 for monitoring. Also, based on the configuration set by the processor circuitry 310, the waveform processor circuitry 318 adjusts itself to measure the at least one signal. In the example of FIG. 3, depending on the configuration, the waveform processor circuitry 318 can perform various measurement types. For example, the configuration is based on the underlying topology and type of control used for the power electronics circuit 304. As such, at least one measurement performed by the waveform processor circuitry 318 is based on the underlying topology and type of control used for the power electronics circuit 304.

In the illustrated example of FIG. 3, the waveform processor circuitry 318 performs one or more measurements based on a comparison between two edges of a signal. For example, the distance between the two edges of the signal is configurable (e.g., based on the configuration). In the example of FIG. 3, by comparing edge-0 to edge-1 in a signal, the waveform processor circuitry 318 can determine the duty cycle of the signal. Also, for example, by comparing edge-0 to edge-2 in a signal, the waveform processor circuitry 318 can determine the period of the signal. In some examples, by comparing edge-0 in a signal to a later edge in the signal (e.g., anywhere between edge-3 and edge-16), the waveform processor circuitry 318 can determine the period of the signal over longer switching cycle. In the example of FIG. 3, the waveform processor circuitry 318 performs one or more measurements based on a comparison of phase overlap and frequency of a signal. For example, the comparison is based on a programmable time window defined based on the configuration set by the processor circuitry 310. In the example of FIG. 3, the waveform processor circuitry 318 performs one or more measurements by accumulating successive measurements for N samples (e.g., a predetermined number of samples) and determining an average value of the N samples or a peak value over the N samples.

In the illustrated example of FIG. 3, based on receiving a trigger (e.g., from the processor circuitry 310, from another component of the SoC 302, from a component external to the SoC 302, etc.), the waveform processor circuitry 318 measures (e.g., is configured to measure) the at least one signal over an amount of time (e.g., based on the configuration) to generate a first value. In the example of FIG. 3, the waveform processor circuitry 318 compares the first value to a second value. In some examples, the second value is a programmed value based on the configuration set by the processor circuitry 310. Also or alternatively, the second value is based on another signal generated by a corresponding redundant component. For example, if the configuration indicates that the waveform processor circuitry 318 is to monitor a signal output by the primary sensor circuitry 324_{A} (e.g., a primary signal), then the waveform processor circuitry 318 also selects a signal output by the redundant sensor circuitry 324_{B} (e.g., a redundant signal) for monitoring. In such examples, the waveform processor circuitry 318 measures the signal generated by the corresponding redundant component over the amount of time to generate the second value.

In the illustrated example of FIG. 3, to compare the first value to the second value, the waveform processor circuitry 318 determines a difference between the first value and the second value. Also or alternatively, the waveform processor circuitry 318 compares the first value and the second value in another manner. In the example of FIG. 3, the waveform processor circuitry 318 determines if the comparison satisfies at least one of an outer threshold or an inner threshold for the at least one signal. For example, the waveform processor circuitry 318 determines whether the difference between the first value and the second value is less than at least one of the outer threshold or the inner threshold. In some examples, the comparison satisfies at least one of the outer threshold or the inner threshold in another manner (e.g., less than or equal to, equal to, greater than, greater than or equal to, etc.).

In the illustrated example of FIG. 3, the outer threshold corresponds a fault in the power electronics circuit 304. For example, the fault is associated with the at least one signal monitored by the waveform processor circuitry 318. In the example of FIG. 3, the inner threshold corresponds to a condition in the power electronics circuit 304 that may develop into a fault without intervention. For example, the condition is associated with the at least one signal monitored by the waveform processor circuitry 318. As described below, at least one of the outer threshold or the inner threshold are programmable and can be adjusted by the processor circuitry 310 (e.g., based on the configuration for the waveform processor circuitry 318).

In the illustrated example of FIG. 3, based on the comparison between the first value and the second value satisfying at least one of the outer threshold or the inner threshold, the waveform processor circuitry 318 sends an interrupt to processor circuitry (e.g., the processor circuitry 310 or the system control circuitry 308). For example, based on the comparison satisfying the outer threshold, the waveform processor circuitry 318 sends an interrupt to processor circuitry to indicate that the outer threshold for the at least one signal has been satisfied. Also, for example, based on the comparison satisfying the inner threshold, the waveform processor circuitry 318 sends an interrupt to processor circuitry to indicate that the inner threshold for the at least one signal has been satisfied.

In the illustrated example of FIG. 3, the processor circuitry to which the waveform processor circuitry 318 sends an interrupt includes at least one of the processor circuitry 310 or the system control circuitry 308. For example, if the condition or fault corresponding to a satisfied threshold originates in a component that is not at least one of the primary processor circuitry 310_{A} or the redundant processor circuitry 310_{B}, then the waveform processor circuitry 318 sends the interrupt to the processor circuitry 310. Also, for example, if the condition or fault corresponding to a satisfied threshold originates in at least one of the primary processor circuitry 310_{A} or the redundant processor circuitry 310_{B}, then the waveform processor circuitry 318 sends the interrupt to the system control circuitry 308. In this manner, even if a fault corresponding to a satisfied threshold originates in the processor circuitry 310, the system control circuitry 308 can send a signal to the gate driver circuitry 306 to place the power electronics circuit 304 into a safety state.

As described herein, the waveform processor circuitry 318 performs analysis and diagnostics of time domain signals generated at least one of within the SoC 302 (e.g., a PWM signal) or external to the SoC 302 (e.g., a signal driven from a power stage such as a gate driver control feedback signal). As such, the waveform processor circuitry 318 supports automated analysis of different types of control of the power electronics circuit 304 based on programming (e.g., a software configuration) from at least one of the processor circuitry 310. In the example of FIG. 3, based on receiving an interrupt from the waveform processor circuitry 318, the processor circuitry 310 determines whether the interrupt indicates that the outer threshold has been satisfied.

In the illustrated example of FIG. 3, based on the interrupt indicating that the outer threshold has been satisfied, the processor circuitry 310 determines whether a safety state was triggered for the power electronics circuit 304. For example, some implementations of the gate driver circuitry 306 include the capability to disable (e.g., open) the switch 328 in the event of a fault and communicate whether the switch 328 has been disabled to the processor circuitry 310. In the example of FIG. 3, if a safety state was not triggered for the power electronics circuit 304, the processor circuitry 310 triggers the safety state for the power electronics circuit 304. For example, the processor circuitry 310 sends a signal to cause the gate driver circuitry 306 to disable the switch 328. Also, if a safety state was not triggered for the power electronics circuit 304, the processor circuitry 310 sets an error status for the power electronics circuit 304.

In the illustrated example of FIG. 3, in the event that a safety state was triggered for the power electronics circuit 304, the processor circuitry 310 determines whether to adjust the at least one setting of the controller for the power electronics circuit 304. For example, the processor circuitry 310 can adjust at least one setting of the controller implemented by the controls circuitry 312 while maintaining the same control mode. If the processor circuitry 310 determines to adjust the at least one setting of the controller for the power electronics circuit 304, the processor circuitry 310 updates the controls circuitry 312 to implement the adjustment. Also, if the processor circuitry 310 determines to adjust the at least one setting of the controller for the power electronics circuit 304, the processor circuitry 310 updates the configuration for the waveform processor circuitry 318 and loads the updated configuration into the memory 314 or communicates the updated configuration to the waveform processor circuitry 318.

In the illustrated example of FIG. 3, if the processor circuitry 310 determines not to adjust the at least one setting of the controller for the power electronics circuit 304, the processor circuitry 310 records an error code for the interrupt in the memory 314. Subsequently, the processor circuitry 310 resets the waveform processor circuitry 318. In the example of FIG. 3, as described above, the processor circuitry 310 determines whether a received interrupt indicates that the outer threshold has been satisfied. Based on the interrupt not indicating that the outer threshold has been satisfied, the processor circuitry 310 determines whether the received interrupt indicates that the inner threshold has been satisfied. Based on the interrupt not indicating that the inner threshold has been satisfied, the processor circuitry 310 records an error code for the interrupt in the memory 314 and resets the waveform processor circuitry 318.

In the illustrated example of FIG. 3, based on the interrupt indicating that the inner threshold has been satisfied, the processor circuitry 310 determines whether to adjust the at least one setting of the controller for the power electronics circuit 304. For example, as described above, the inner threshold corresponds to a condition in the power electronics circuit 304 that may develop into a fault without intervention. Depending on how close the measurement of the signal is to the outer threshold, the processor circuitry 310 determines whether to adjust at least one setting of the controller implemented by the controls circuitry 312. As such, if the inner threshold is satisfied for a signal, the processor circuitry 310 determines to track the signal for one or more subsequent measurements. If the signal continues to satisfy the inner threshold for at least one additional measurement, then the processor circuitry 310 determines to adjust the at least one setting of the controller for the power electronics circuit 304.

For example, the processor circuitry 310 utilizes the model of the power electronics circuit 304 to predict a future state of the power electronics circuit 304 for a candidate adjustment to a setting of the controller for the power electronics circuit 304. As such, the processor circuitry 310 can determine whether the candidate adjustment causes the signal that satisfied the inner threshold to trend away from the outer threshold. In this manner, the processor circuitry 310 can prevent faults from occurring based on feedback from the waveform processor circuitry 318. In the example of FIG. 3, based on a prediction rendered by the model of the power electronics circuit 304, the processor circuitry 310 updates the configuration for the waveform processor circuitry 318.

In the illustrated example of FIG. 3, based on the processor circuitry 310 determining not to adjust the at least one setting of the controller for the power electronics circuit 304, the processor circuitry 310 determines whether to change a control mode of the controller. Based on the processor circuitry 310 determining to change the control mode of the controller, the processor circuitry 310 programs at least one setting for the controller based on a model of the power electronics circuit 304 for the new control mode. Based on the processor circuitry 310 determining not to change the control mode of the controller, the processor circuitry 310 determines whether the interrupt is a false positive.

In the illustrated example of FIG. 3, based on the processor circuitry 310 determining that the interrupt is not a false positive, the processor circuitry 310 records an error code for the interrupt in the memory 314. Based on the processor circuitry 310 determining that the interrupt is a false positive, the processor circuitry 310 adjusts the inner threshold for the at least one signal. For example, the processor circuitry 310 adjusts the inner threshold to prevent additional false positives. An adjustable inner threshold may allow for more flexible operation of the processor circuitry 310 and of the waveform processor circuitry 318. As described herein, the processor circuitry 310 implements machine-readable instructions (e.g., software, firmware, etc.) to dynamically configure the waveform processor circuitry 318 to compare one or more signals based on at least one of the topology of the power electronics circuit 304, the type of control mode utilized to control the power electronics circuit 304, or on-the-fly feedback from the waveform processor circuitry 318. In this manner, the processor circuitry 310 auto-tunes the margin of variation (e.g., at least one of the inner threshold or outer threshold) for signal comparison based on one or more interrupts by extrapolating measurements generated by the waveform processor circuitry 318. As such, the processor circuitry 310 avoids at least one of false positives or false negatives.

As described above, the SoC 302 includes the processor circuitry 310, the controls circuitry 312, and the waveform processor circuitry 318. Also, as described above, the controls circuitry 312 implements a controller that provides a safe power electronics system including at least one of pulse width modulation, phase modulation, or frequency modulation for control of the switch 328 using diverse components. As described above, the SoC 302 includes the waveform processor circuitry 318 to perform analysis and determine diagnostics of time domain signals associated with the controller implemented by the controls circuitry 312. Also, at least one of the primary processor circuitry 310_{A} or the redundant processor circuitry 310_{B} executes machine-readable instructions (e.g., software, firmware, etc.) to adaptively configure the waveform processor circuitry 318 to render reliable signal comparison and auto-tune margins (e.g., thresholds) for heterogenous reciprocal comparison.

As such, examples described herein include reciprocal comparison with diverse components (e.g., in terms of at least one of manufactures or ISAs) which increases safety integrity in power electronics systems. Also, examples described herein provide reliable monitoring by tuning the permitted margin of variation (e.g., threshold) in an on-line manner. Furthermore, by at least one of averaging measurements or utilizing a peak value for comparisons, examples described herein eliminate noise (e.g., non-representative measurements). Example waveform processor circuitry described herein is flexible and can be configured for a variety of monitoring which supports any type of power electronics controller.

Also, by implementing example waveform processor circuitry described herein with hardware, examples described herein include automated (e.g., fully automated) monitoring that saves MIPS. In some examples, waveform processor circuitry described herein can be implemented with programmable processor circuitry (e.g., a complex programmable logic device, a field programmable gate array, etc.). However, such implementations may require more area in a system, cost more money to implement, and increase latency in signal paths being monitored.

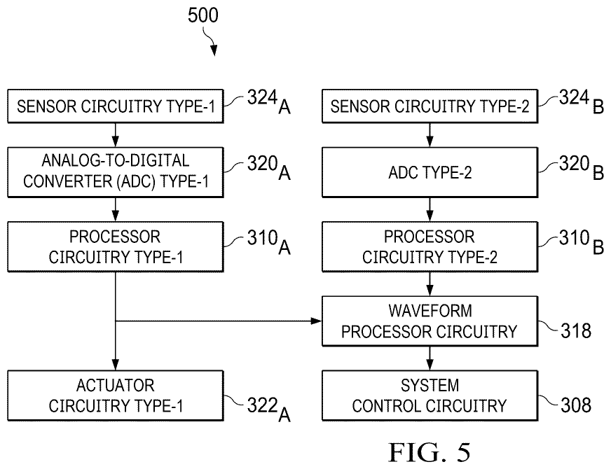

FIG. 4 is a block diagram of an example implementation of the waveform processor circuitry 318 of FIG. 3. The example waveform processor circuitry 318 of FIG. 4 includes example communication bus interface circuitry 402, example crossbar circuitry 404, example measurement circuitry 406, and example analysis circuitry 408. In the example of FIG. 4, the waveform processor circuitry 318 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of instructions to perform operations. Some or all of the circuitry of FIG. 2 may, thus, be instantiated at the same or different times. Also or alternatively, the waveform processor circuitry 318 of FIG. 4 may be instantiated (e.g., creating an instance of, bring into being for any length of time, materialize, implement, etc.) by programmable circuitry such as a Central Processor Unit (CPU) executing the instructions. Some or all of the circuitry of FIG. 2 may be instantiated, for example, in one or more threads executing concurrently on hardware or in series on hardware.

In the illustrated example of FIG. 4, the communication bus interface circuitry 402 has an input terminal, an output terminal, and an I/O terminal. In the example of FIG. 4, the crossbar circuitry 404 has a first input terminal, a second input terminal, and an output terminal. Also, the measurement circuitry 406 has a first input terminal, a second input terminal, and an output terminal. In the example of FIG. 4, the analysis circuitry 408 has an input terminal, a first output terminal, a second output terminal, a first I/O terminal, and a second I/O terminal. In the example of FIG. 4, one or more of the components of FIG. 4 may include one or more terminals than those illustrated in FIG. 4. For example, each terminal illustrated in FIG. 4 may, in reality, be implemented by more than one terminal.

In the illustrated example of FIG. 4, the communication bus interface circuitry 402 is implemented by at least one of analog circuitry or digital circuitry. In the example of FIG. 4, the input terminal of the communication bus interface circuitry 402 is coupled to the communication bus 326. For example, the input terminal of the communication bus interface circuitry 402 corresponds to the first input terminal of the waveform processor circuitry 318. In the example of FIG. 4, the output terminal of the communication bus interface circuitry 402 is coupled to the second input terminal of the measurement circuitry 406. Also, the I/O terminal of the communication bus interface circuitry 402 is coupled to the second I/O terminal of the analysis circuitry 408.

In the illustrated example of FIG. 4, the crossbar circuitry 404 is implemented by at least one of analog circuitry or digital circuitry. In the example of FIG. 4, the first input terminal of the crossbar circuitry 404 is coupled to the processor circuitry 310. For example, the first input terminal of the crossbar circuitry 404 is coupled to the output terminal of the primary processor circuitry 310_{A} and the output terminal of the redundant processor circuitry 310_{B}. In the example of FIG. 4, the first input terminal of the crossbar circuitry 404 corresponds to the third input terminal of the waveform processor circuitry 318. In the example of FIG. 4, the second input terminal of the crossbar circuitry 404 is coupled to the controls circuitry 312.

For example, the second input terminal of the crossbar circuitry 404 is coupled to the output terminal of the primary ADC 320_{A}, the output terminal of the redundant ADC 320_{B}, the first output terminal of the primary actuator circuitry 322_{A}, the output terminal of the redundant actuator circuitry 322_{B}, the first output terminal of the primary sensor circuitry 324_{A}, and the output terminal of the redundant sensor circuitry 324_{B}. In the example of FIG. 4, the second input terminal of the crossbar circuitry 404 corresponds to the second input terminal of the waveform processor circuitry 318. Also or alternatively, one or more components (e.g., primary components or redundant components) external to the SoC 302 may be coupled to the crossbar circuitry 404. In the example of FIG. 4, the output terminal of the crossbar circuitry 404 is coupled to the first input terminal of the measurement circuitry 406.

In the illustrated example of FIG. 4, the measurement circuitry 406 is implemented by at least one of analog circuitry or digital circuitry. In the example of FIG. 4, the first input terminal of the measurement circuitry 406 is coupled to the output terminal of the crossbar circuitry 404. Also, the second input terminal of the measurement circuitry 406 is coupled to the output terminal of the communication bus interface circuitry 402. In the example of FIG. 4, the output terminal of the measurement circuitry 406 is coupled to the input terminal of the analysis circuitry 408.

In the illustrated example of FIG. 4, the analysis circuitry 408 is implemented by at least one of analog circuitry or digital circuitry. In the example of FIG. 4, the input terminal of the analysis circuitry 408 is coupled to the output terminal of the measurement circuitry 406. Also, the first output terminal of the analysis circuitry 408 is coupled to the processor circuitry 310. For example, the first output terminal of the analysis circuitry 408 is coupled to the input terminal of the primary processor circuitry 310_{A} and the input terminal of the redundant processor circuitry 310_{B}. In the example of FIG. 4, the first output terminal of the analysis circuitry 408 corresponds to the third output terminal of the waveform processor circuitry 318.

In the illustrated example of FIG. 4, the second output terminal of the analysis circuitry 408 is coupled to the system control circuitry 308. For example, the second output terminal of the analysis circuitry 408 is coupled to the input terminal of the system control circuitry 308. In the example of FIG. 4, the second output terminal of the analysis circuitry 408 corresponds to the second output terminal of the waveform processor circuitry 318. Also, the first I/O terminal of the analysis circuitry 408 is coupled to the DMA circuitry 316. For example, the first I/O terminal of the analysis circuitry 408 is coupled to the third I/O terminal of the DMA circuitry 316. In the example of FIG. 4, the first I/O terminal of the analysis circuitry 408 corresponds to the I/O terminal of the waveform processor circuitry 318. Also, the second I/O terminal of the analysis circuitry 408 is coupled to the I/O terminal of the communication bus interface circuitry 402.

In the illustrated example of FIG. 4, as described above, the processor circuitry 310 sets a configuration for the waveform processor circuitry 318 based on a model for the power electronics circuit 304. For example, the processor circuitry 310 sets a configuration for the waveform processor circuitry 318 via the communication bus 326. In some examples, the processor circuitry 310 sets the configuration for the waveform processor circuitry 318 in the memory 314. As described above, the model for the power electronics circuit 304 is based on at least one of the topology of the power electronics circuit 304 or the control mode for the power electronics circuit 304.

In the illustrated example of FIG. 4, the communication bus interface circuitry 402 accesses the configuration. For example, the communication bus interface circuitry 402 accesses the configuration from the processor circuitry 310 via the communication bus 326. Also or alternatively, the communication bus interface circuitry 402 accesses the configuration from the memory 314 via the DMA circuitry 316. In the example of FIG. 4, the communication bus interface circuitry 402 includes one or more registers that can be set or programmed based on the configuration. As such, after accessing the configuration (e.g., from the processor circuitry 310, from the memory 314, etc.), the communication bus interface circuitry 402 communicates the configuration to at least one of the measurement circuitry 406 or the analysis circuitry 408. Based on the configuration, the measurement circuitry 406 selects at least one signal associated with the power electronics circuit 304 for monitoring.

For example, the crossbar circuitry 404 facilitates monitoring of at least one of the primary processor circuitry 310_{A}, the redundant processor circuitry 310_{B}, the primary ADC 320_{A}, the redundant ADC 320_{B}, the primary actuator circuitry 322_{A}, the redundant actuator circuitry 322_{B}, the primary sensor circuitry 324_{A}, or the redundant sensor circuitry 324_{B}. Also or alternatively, the crossbar circuitry 404 facilitates monitoring of one or more components (e.g., primary components or redundant components) external to the SoC 302. As such, the waveform processor circuitry 318 is fully configurable as to the choice of input signals from within the SoC 302 (e.g., a PWM signal, an ADC signal, a comparator signal, etc.) or from outside the SoC 302 (e.g., a gate driver input signal, an I/O trigger, an I/O pulse, etc.).

In the illustrated example of FIG. 4, based on the configuration set by the processor circuitry 310, the measurement circuitry 406 selects at least one signal available from the crossbar circuitry 404. Also, based on the configuration set by the processor circuitry 310, the measurement circuitry 406 adjusts itself to measure the at least one signal. For example, depending on the configuration, the measurement circuitry 406 can perform various measurement types. For example, the measurement circuitry 406 performs at least one of a phase measurement, a frequency measurement (e.g., based on edges of signal in time), a pulse width measurement (e.g., a duty cycle of a signal, a period of a signal, etc.), or a dead-band measurement to characterize a waveform. In some examples, the measurement circuitry 406 performs additional or alternative measurements.

For example, the measurement circuitry 406 performs one or more measurements based on a comparison between two edges of a signal. For example, the distance between the two edges of the signal is configurable (e.g., based on the configuration set by the processor circuitry 310). In the example of FIG. 4, by comparing edge-0 to edge-1 in a signal, the measurement circuitry 406 can determine the duty cycle of the signal. Also, for example, by comparing edge-0 to edge-2 in a signal, the measurement circuitry 406 can determine the period of the signal. In some examples, by comparing edge-0 in a signal to a later edge in the signal (e.g., anywhere between edge-3 and edge-16), the measurement circuitry 406 can determine the period of the signal over longer switching cycle.

In the illustrated example of FIG. 4, based on receiving a trigger (e.g., from the processor circuitry 310, from another component of the SoC 302, from a component external to the SoC 302, etc.), the crossbar circuitry 404 causes the measurement circuitry 406 to measure at least one signal over an amount of time (e.g., based on the configuration) to generate a value indicative of a measurement. In the example of FIG. 4, example triggers include a CPU interrupt, a DMA interface event, an output event at least one of to or from at least one of the primary actuator circuitry 322_{A} or the redundant actuator circuitry 322_{B}, and an output event at least one of to or from another component (e.g., at least one of a primary component or a redundant component that is at least one of within or external to the SoC 302). As such, measurements of multiple signals can be triggered such that the measurements start from a specific clock cycle or time instance.

In the illustrated example of FIG. 4, after performing a measurement of a signal, the measurement circuitry 406 communicates a value indicative of the measurement to the analysis circuitry 408. In the example of FIG. 4, the analysis circuitry 408 compares at least one value received from the measurement circuitry 406 to a second value. For example, the second value is a programmed value based on the configuration set by the processor circuitry 310. In some examples, the second value is based on another signal generated by a corresponding redundant component. In the example of FIG. 4, the measurement circuitry 406 can be configured to characterize two waveforms contemporaneously (e.g., simultaneously). For example, if the configuration indicates that the measurement circuitry 406 is to monitor a signal output by the primary sensor circuitry 324_{A}, then the measurement circuitry 406 also selects a signal output by the redundant sensor circuitry 324_{B} for monitoring. In such examples, the measurement circuitry 406 measures the signal generated by the corresponding redundant component over the amount of time to generate the second value. Also, in such examples, the measurement circuitry 406 forwards the second value to the analysis circuitry 408.

In the illustrated example of FIG. 4, the analysis circuitry 408 supports multiple forms of analysis of measurements determined by the measurement circuitry 406. In the example of FIG. 4, the analysis circuitry 408 compares a first value to a second value. In some examples, the first value is a value received directly from the measurement circuitry 406. Also or alternatively, the analysis circuitry 408 performs post processing on measurements received from the measurement circuitry 406 to generate the first value. For example, once a parameter is measured by the measurement circuitry 406, the analysis circuitry 408 accumulates measurements of the parameter for a number of measurements (e.g., N samples) as specified by the configuration programmed by the processor circuitry 310. Based on the accumulated measurements, the analysis circuitry 408 determines at least one of an average value of the accumulated measurements or a peak value over the accumulated measurements.

In the illustrated example of FIG. 4, to compare the first value to the second value, the analysis circuitry 408 determines a difference between the first value and the second value. Also or alternatively, the analysis circuitry 408 compares the first value and the second value in another manner. In some examples, the analysis circuitry 408 compares phase overlap between two signals. Also or alternatively, the analysis circuitry 408 compares the frequency of two signals. In some examples, the comparison performed by the analysis circuitry 408 is based on a programmable time window defined based on the configuration set by the processor circuitry 310.

In the illustrated example of FIG. 4, the analysis circuitry 408 determines if the comparison satisfies at least one of an outer threshold or an inner threshold for the at least one signal. As described above, the outer threshold corresponds a fault in the power electronics circuit 304 and the inner threshold corresponds to a condition in the power electronics circuit 304 that may develop into a fault without intervention. Also, at least one of the outer threshold or the inner threshold is programmable based on the configuration set by the processor circuitry 310. As such, the processor circuitry 310 can specify minimum (e.g., the inner threshold) and maximum (e.g., the outer threshold) comparison points to permit the analysis circuitry 408 to compare signal measurements within a range as opposed to against a fixed value.

As described above, the analysis circuitry 408 determines if the comparison satisfies at least one of an outer threshold or an inner threshold for the at least one signal. For example, the analysis circuitry 408 determines whether a difference between a first value and a second value is less than at least one of the outer threshold or the inner threshold. In some examples, the comparison satisfies at least one of the outer threshold or the inner threshold in another manner (e.g., less than or equal to, equal to, greater than, greater than or equal to, etc.). In the example of FIG. 4, the analysis circuitry 408 can be configured by the processor circuitry 310 to have separate thresholds of configuration for each measurement received from the measurement circuitry 406.

Also or alternatively, the analysis circuitry 408 can be configured by the processor circuitry 310 to have a moving window of analysis (e.g., for frequency analysis). For example, the analysis circuitry 408 can be configured to analyze a first measurement over a first time period of a signal and then configured to analyze a second measurement over a second time period of the signal that overlaps with the first time period by some amount. As such, the analysis circuitry 408 can track a signal over time to determine an overarching pattern in the signal (e.g., monotony of a signal). Also, as described above, the analysis circuitry 408 includes the first I/O terminal which is coupled to the DMA circuitry 316. As such, the analysis circuitry 408 can access an updated configuration without intervention from the processor circuitry 310. For example, the memory 314 stores a lookup table (LUT) including a variety of values for different comparisons. Accordingly, the analysis circuitry 408 can access the LUT based on a given signal to determine a value against which to compare the signal.

As described above, at least one of the measurement circuitry 406 or the analysis circuitry 408 can be configured by the processor circuitry 310. For example, for a given type of comparison, edges to be compared, polarity of edges to be compared, a time window (e.g., for frequency analysis) for analysis, and whether the comparison is for single waveform analysis or multi-waveform analysis (e.g., two or more signals) are all programmable attributes of the waveform processor circuitry 318. As such, a large number of waveforms can be at least one of characterized individually or compared against each other. Table 1 below illustrates example topologies and control modes for the power electronics circuit 304 as well as example measurements that can be performed by the waveform processor circuitry 318. For example, frequency is a control parameter for resonant converters. As such, by directly measuring and analyzing PWM output frequency, the waveform processor circuitry 318 can detect (e.g., quickly detect) faults in resonant converters via reciprocal comparison.

TABLE 1

| Measurement | Applicable | | |
|---|---|---|---|
| Parameter | Topologies | Control Modes | |
| Pulse width | Phase Shifted | 1. | Peak current mode control |
| | Full Bridge | | (PCMC) |
| | | 2. | Average current mode control |
| | | | (ACMC) |
| Pulse Width | LLC converter | 1. | Hybrid Hysteretic Control |
| | | 2. | Clamped frequency mode |
| Frequency | Resonant CLLC | 1. | Moving between high to low Q |
| | converter | | for dominant parallel or |
| | | | series resonant action |
| Phase overlap | Dual Active | 1. | Single Phase Switching (SPS) |
| | Bridge | 2. | Double Phase Switching (DPS) |
| | | 3. | Extended Phase Switching (EPS) |
| | | 4. | Triple Phase Switching (TPS) |

In the illustrated example of FIG. 4, as described above, the analysis circuitry 408 compares at least one value received from the measurement circuitry 406 to a second value. Based on the comparison satisfying at least one of the outer threshold or the inner threshold, the analysis circuitry 408 sends an interrupt to processor circuitry (e.g., the processor circuitry 310 or the system control circuitry 308). For example, based on the comparison satisfying the outer threshold, the analysis circuitry 408 sends an interrupt to processor circuitry to indicate that the outer threshold for the at least one signal has been satisfied. Also, for example, based on the comparison satisfying the inner threshold, the analysis circuitry 408 sends an interrupt to processor circuitry to indicate that the inner threshold for the at least one signal has been satisfied.

In the illustrated example of FIG. 4, the processor circuitry to which the analysis circuitry 408 sends an interrupt includes at least one of the processor circuitry 310 or the system control circuitry 308. For example, if the condition or fault corresponding to a satisfied threshold originates in a component that is not at least one of the primary processor circuitry 310_{A} or the redundant processor circuitry 310_{B}, then the analysis circuitry 408 sends the interrupt to the processor circuitry 310. Also, for example, if the condition or fault corresponding to a satisfied threshold originates in at least one of the primary processor circuitry 310_{A} or the redundant processor circuitry 310_{B}, then the analysis circuitry 408 sends the interrupt to the system control circuitry 308. In this manner, even if a fault corresponding to a satisfied threshold originates in the processor circuitry 310, the system control circuitry 308 can send a signal to the gate driver circuitry 306 to place the power electronics circuit 304 into a safety state.

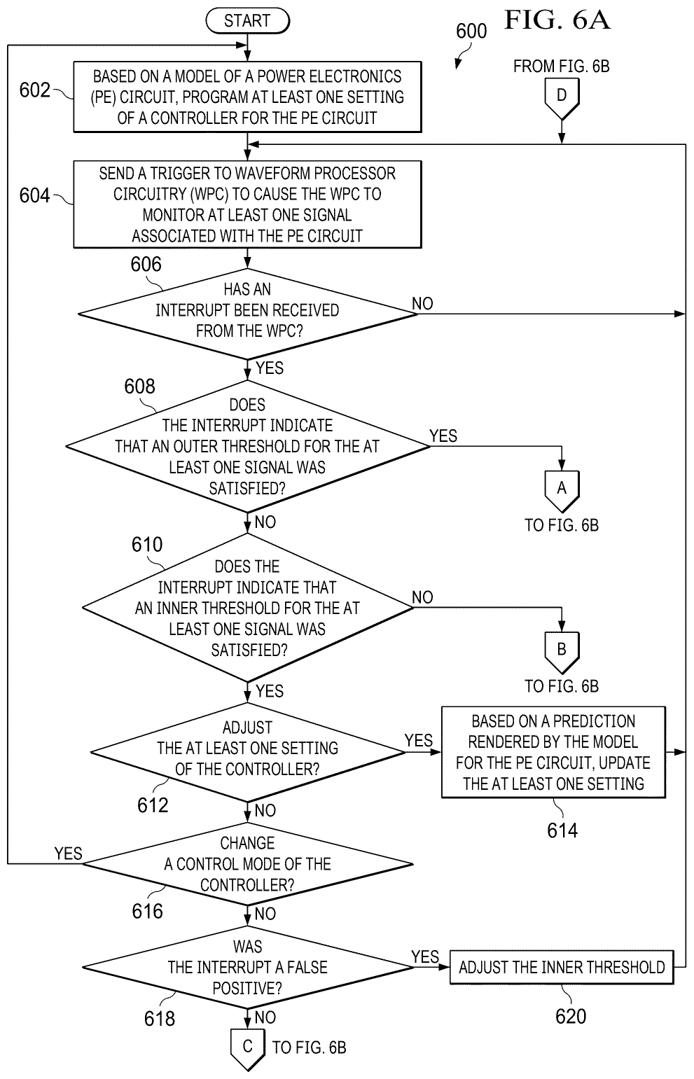

FIG. 5 is a block diagram illustrating an example processing path 500 for signals monitored by the waveform processor circuitry 318 of FIG. 3. In the example of FIG. 5, the primary sensor circuitry 324_{A} and the redundant sensor circuitry 324_{B} monitor a signal associated with the power electronics circuit 304. Also, the primary sensor circuitry 324_{A} forwards a first sample to the primary ADC 320_{A} and the redundant sensor circuitry 324_{B} forwards a second sample to the redundant ADC 320_{B}. In the example of FIG. 5, the primary ADC 320_{A} and the redundant ADC 320_{B} convert the first sample and the second sample from the analog domain to the digital domain, respectively.

In the illustrated example of FIG. 5, the primary ADC 320_{A} forwards the digital domain first sample to the primary processor circuitry 310_{A} and the redundant ADC 320_{B} forwards the digital domain second sample to the redundant processor circuitry 310_{B}. Based on the first sample, the primary processor circuitry 310_{A} determines a primary control signal to send to the primary actuator circuitry 322_{A}. Also, based on the second sample, the redundant processor circuitry 310_{B} determines a redundant control signal. In the example of FIG. 5, the primary processor circuitry 310_{A} sends the primary control signal to the primary actuator circuitry 322_{A} and the waveform processor circuitry 318. Also, the redundant processor circuitry 310_{B} sends the redundant control signal to the waveform processor circuitry 318.

In the illustrated example of FIG. 5, the waveform processor circuitry 318 compares the primary control signal to the redundant control signal. For example, the waveform processor circuitry 318 determines a difference between the primary control signal and the redundant control signal. Also, the waveform processor circuitry 318 determines if the comparison satisfies at least one of the outer threshold or the inner threshold for the control signal. Based on the comparison between the primary control signal and the redundant control signal satisfying at least one of the outer threshold or the inner threshold, the waveform processor circuitry 318 transmits an interrupt to the system control circuitry 308 to cause the system control circuitry 308 to place the power electronics circuit 304 into a safety state.

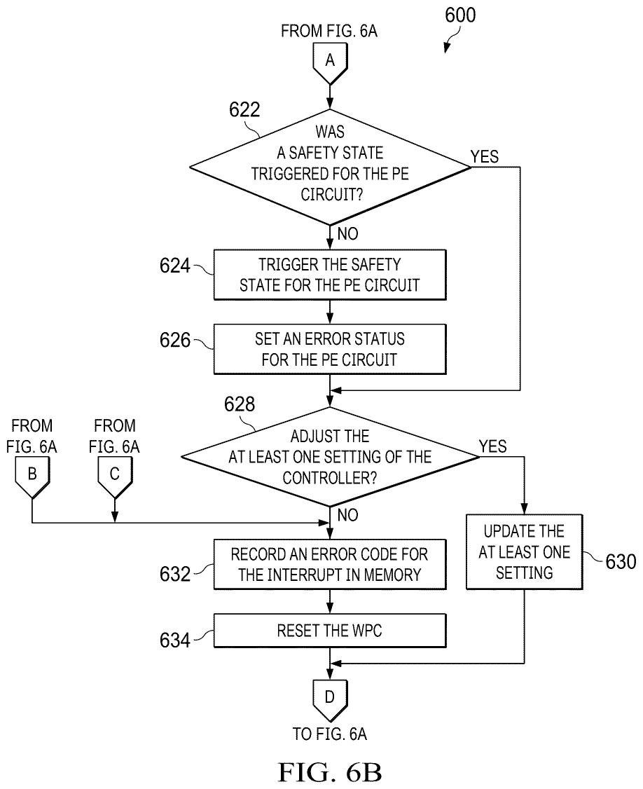

FIG. 6 is a flowchart representative of at least one of example machine-readable instructions or example operations 600 that may be at least one of executed, instantiated, or performed using an example programmable circuitry implementation of at least one of the primary processor circuitry 310_{A} or the redundant processor circuitry 310_{B} of FIG. 3. For purposes of clarity, FIG. 6 is described with respect to the processor circuitry 310. However, any of the primary processor circuitry 310_{A} or the redundant processor circuitry 310_{B} can perform any of the blocks of at least one of the example machine-readable instructions or the example operations 600 of FIG. 6.

In the illustrated example of FIG. 6, at least one of the example machine-readable instructions or the example operations 600 of FIG. 6 begin at block 602, at which the processor circuitry 310, based on a model of the power electronics circuit 304, programs at least one setting of a controller for the power electronics circuit 304. For example, the processor circuitry 310 programs at least one setting for the controls circuitry 312 based on the model of the power electronics circuit 304. Also, the processor circuitry 310 programs a configuration for the waveform processor circuitry 318 based on the model for the power electronics circuit 304. For example, the processor circuitry 310 programs a configuration for the waveform processor circuitry 318 via the communication bus 326. In some examples, the processor circuitry 310 programs the configuration for the waveform processor circuitry 318 in the memory 314.

In the illustrated example of FIG. 6, at block 604, the processor circuitry 310 sends a trigger to the waveform processor circuitry 318 to cause the waveform processor circuitry 318 to monitor at least one signal associated with the power electronics circuit 304. At block 606, the processor circuitry 310 determines whether an interrupt has been received from the waveform processor circuitry 318. Based on (e.g., in response to), the processor circuitry 310 determining that an interrupt has not been received from the waveform processor circuitry 318 (block 606: NO), at least one of the machine-readable instructions or the operations 600 return to block 604. Also, based on (e.g., in response to), the processor circuitry 310 determining that an interrupt has been received from the waveform processor circuitry 318 (block 606: YES), at least one of the machine-readable instructions or the operations 600 proceed to block 608.

In the illustrated example of FIG. 6, at block 608, the processor circuitry 310 determines whether the interrupt indicates that an outer threshold for the at least one signal was satisfied. Based on (e.g., in response to) the interrupt indicating that the outer threshold has been satisfied (block 608: YES), at least one of the machine-readable instructions or the operations 600 proceed to block 622. Based on (e.g., in response to) the interrupt not indicating that the outer threshold has been satisfied (block 608: NO), at least one of the machine-readable instructions or the operations 600 proceed to block 610. At block 610, the processor circuitry 310 determines whether the received interrupt indicates that the inner threshold has been satisfied.

In the illustrated example of FIG. 6, based on (e.g., in response to) the interrupt not indicating that the inner threshold has been satisfied (block 610: NO), at least one of the machine-readable instructions or the operations 600 proceed to block 632. Based on (e.g., in response to) the interrupt indicating that the inner threshold has been satisfied (block 610: YES), at least one of the machine-readable instructions or the operations 600 proceed to block 612. At block 612, the processor circuitry 310 determines whether to adjust the at least one setting of the controller for the power electronics circuit 304. For example, as described above, the inner threshold corresponds to a condition in the power electronics circuit 304 that may develop into a fault without intervention.

As described above, depending on how close the measurement of the signal is to the outer threshold, the processor circuitry 310 determines whether to adjust at least one setting of the controller implemented by the controls circuitry 312. As such, if the inner threshold is satisfied for a signal, the processor circuitry 310 determines to track the signal for one or more subsequent measurements. If the signal continues to satisfy the inner threshold for at least one additional measurement, then the processor circuitry 310 determines to adjust the at least one setting of the controller for the power electronics circuit 304.

For example, the processor circuitry 310 utilizes the model of the power electronics circuit 304 to predict a future state of the power electronics circuit 304 for a candidate adjustment to a setting of the controller for the power electronics circuit 304. As such, the processor circuitry 310 can determine whether the candidate adjustment causes the signal that satisfied the inner threshold to trend away from the outer threshold. In this manner, the processor circuitry 310 can prevent faults from occurring based on feedback from the waveform processor circuitry 318. In the example of FIG. 6, based on a prediction rendered by the model of the power electronics circuit 304, the processor circuitry 310 updates the configuration for the waveform processor circuitry 318.

In the illustrated example of FIG. 6, based on (e.g., in response to) the processor circuitry 310 determining to adjust the at least one setting of the controller for the power electronics circuit 304 (block 612: YES), at least one of the machine-readable instructions or the operations 600 proceed to block 614. At block 614, the processor circuitry 310, based on a prediction rendered by the model for the power electronics circuit 304, updates the at least one setting. Also, based on the prediction, the processor circuitry 310 updates the configuration for the waveform processor circuitry 318. Based on (e.g., in response to) the processor circuitry 310 determining not to adjust the at least one setting of the controller for the power electronics circuit 304 (block 612: NO), at least one of the machine-readable instructions or the operations 600 proceed to block 616.

In the illustrated example of FIG. 6, at block 616, the processor circuitry 310 determines whether to change a control mode of the controller. Based on (e.g., in response to) the processor circuitry 310 determining to change the control mode of the controller (block 616: YES), at least one of the machine-readable instructions or the operations 600 return to block 602. For example, the processor circuitry 310 programs at least one setting for the controller based on a model of the power electronics circuit 304 for the new control mode. Also, based on the new control mode for the controller, the processor circuitry 310 programs a new configuration for the waveform processor circuitry 318. Based on (e.g., in response to) the processor circuitry 310 determining not to change the control mode of the controller (block 616: NO), at least one of the machine-readable instructions or the operations 600 proceed to block 618.

In the illustrated example of FIG. 6, at block 618, the processor circuitry 310 determines whether the interrupt is a false positive. Based on (e.g., in response to) the processor circuitry 310 determining that the interrupt is not a false positive (block 618: NO), at least one of the machine-readable instructions or the operations 600 proceed to block 632. Based on (e.g., in response to) the processor circuitry 310 determining that the interrupt is a false positive (block 618: YES), at least one of the machine-readable instructions or the operations 600 proceed to block 620. At block 620, the processor circuitry 310 adjusts the inner threshold for the at least one signal. For example, the processor circuitry 310 adjusts the inner threshold to prevent additional false positives.

Returning to block 608, based on (e.g., in response to) the interrupt indicating that the outer threshold has been satisfied (block 608: YES), at least one of the machine-readable instructions or the operations 600 proceed to block 622. At block 622, the processor circuitry 310 determines whether a safety state was triggered for the power electronics circuit 304. For example, some implementations of the gate driver circuitry 306 include the capability to disable (e.g., open) the switch 328 in the event of a fault and communicate whether the switch 328 has been disabled to the processor circuitry 310. In the example of FIG. 6, based on (e.g., in response to) the processor circuitry 310 determining that a safety state was triggered for the power electronics circuit 304 (block 622: YES), at least one of the machine-readable instructions or the operations 600 proceed to block 628. Based on (e.g., in response to) the processor circuitry 310 determining that a safety state was not triggered for the power electronics circuit 304 (block 622: NO), at least one of the machine-readable instructions or the operations 600 proceed to block 624.

In the illustrated example of FIG. 6, at block 624, the processor circuitry 310 triggers the safety state for the power electronics circuit 304. For example, the processor circuitry 310 sends a signal to cause the gate driver circuitry 306 to disable the switch 328. At block 626, the processor circuitry 310 sets an error status for the power electronics circuit 304. At block 628, the processor circuitry 310 determines whether to adjust the at least one setting of the controller for the power electronics circuit 304. For example, the processor circuitry 310 can adjust at least one setting of the controller implemented by the controls circuitry 312 while maintaining the same control mode. Based on (e.g., in response to) the processor circuitry 310 determining to adjust the at least one setting of the controller for the power electronics circuit 304 (block 628: YES), at least one of the machine-readable instructions or the operations 600 proceed to block 630.

In the illustrated example of FIG. 6, at block 630, the processor circuitry 310 updates the controls circuitry 312 to implement the adjustment. Also, the processor circuitry 310 updates the configuration for the waveform processor circuitry 318 and loads the updated configuration into the memory 314 or communicates the updated configuration to the waveform processor circuitry 318. Based on (e.g., in response to) the processor circuitry 310 determining not to adjust the at least one setting of the controller for the power electronics circuit 304 (block 628: NO), at least one of the machine-readable instructions or the operations 600 proceed to block 632. At block 632, the processor circuitry 310 records an error code for the interrupt in the memory 314. At block 634, the processor circuitry 310 resets the waveform processor circuitry 318.

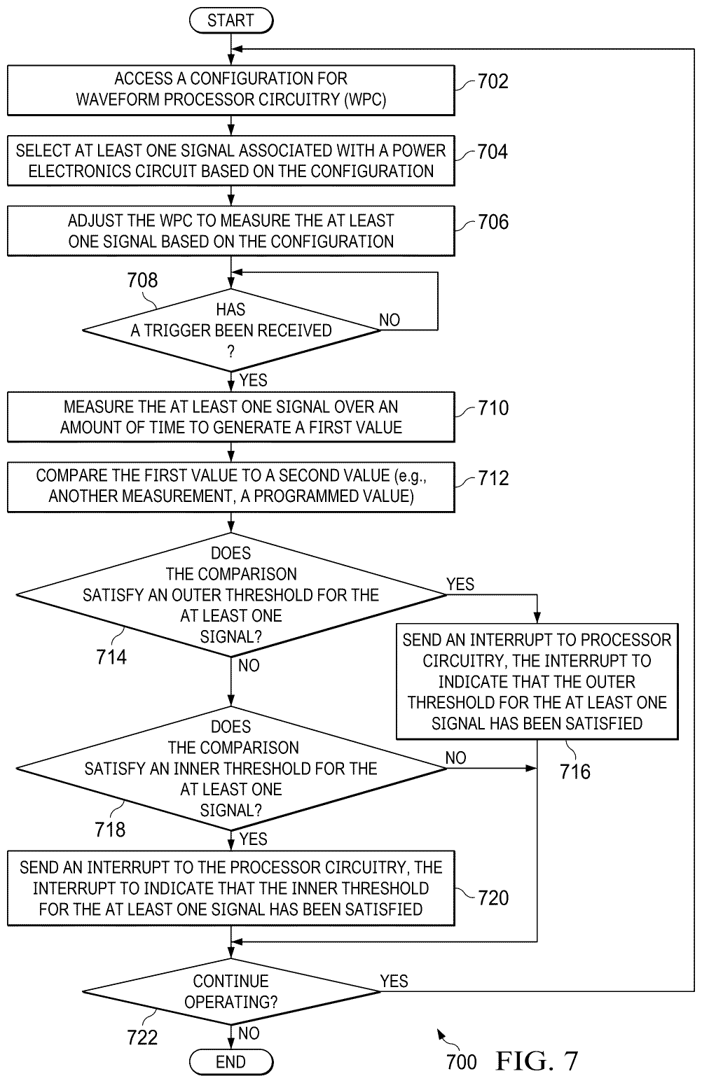

FIG. 7 is a flowchart representative of at least one of example machine-readable instructions or example operations 700 that may be at least one of executed, instantiated, or performed using an example programmable circuitry implementation of the waveform processor circuitry 318 of FIG. 3. In the example of FIG. 7, at least one of the machine-readable instructions or the operations 700 begin at block 702, at which the communication bus interface circuitry 402 accesses a configuration for the waveform processor circuitry 318. For example, the communication bus interface circuitry 402 accesses the configuration from the processor circuitry 310 via the communication bus 326. Also or alternatively, the communication bus interface circuitry 402 accesses the configuration from the memory 314 via the DMA circuitry 316 (e.g., via the communication bus 326).

In the illustrated example of FIG. 7, at block 704, the measurement circuitry 406 selects at least one signal associated with a power electronics circuit (e.g., the power electronics circuit 304) based on the configuration. For example, the measurement circuitry 406 selects the at least one signal from the crossbar circuitry 404. At block 706, the measurement circuitry 406 adjusts the waveform processor circuitry 318 to measure the at least one signal based on the configuration. For example, the measurement circuitry 406 configures itself to perform at least one of a phase measurement, a frequency measurement (e.g., based on edges of signal in time), a pulse width measurement (e.g., a duty cycle of a signal, a period of a signal, etc.), or a dead-band measurement to characterize the at least one signal.

In the illustrated example of FIG. 7, at block 708, the crossbar circuitry 404 determines whether a trigger has been received. Example triggers include a CPU interrupt, a DMA interface event, an output event at least one of to or from at least one of the primary actuator circuitry 322_{A} or the redundant actuator circuitry 322_{B}, and an output event at least one of to or from another component (e.g., at least one of a primary component or a redundant component that is at least one of within or external to the SoC 302). Based on (e.g., in response to) the crossbar circuitry 404 determining that a trigger event has not been received (block 708: NO), at least one of the machine-readable instructions or the operations 700 return to block 708. Based on (e.g., in response to) the crossbar circuitry 404 determining that a trigger event has been received (block 708: YES), at least one of the machine-readable instructions or the operations 700 proceed to block 710. At block 710, the measurement circuitry 406 measures the at least one signal over an amount of time (e.g., based on the configuration) to generate a first value.

In the illustrated example of FIG. 7, at block 712, the analysis circuitry 408 compares the first value to a second value. For example, the second value is a programmed value based on the configuration set by the processor circuitry 310. In some examples, the second value is based on another signal generated by a corresponding redundant component and measured by the measurement circuitry 406. As described above, at block 712, the analysis circuitry 408 compares a first value to a second value. In some examples, the first value is a value received directly from the measurement circuitry 406. Also or alternatively, the analysis circuitry 408 performs post processing on measurements received from the measurement circuitry 406 to generate the first value.

For example, once a signal is measured by the measurement circuitry 406, the analysis circuitry 408 accumulates measurements of the signal for a number of measurements (e.g., N samples) as specified by the configuration programmed by the processor circuitry 310. Based on the accumulated measurements, the analysis circuitry 408 determines at least one of an average value of the accumulated measurements or a peak value over the accumulated measurements. In the example of FIG. 7, to compare the first value to the second value, the analysis circuitry 408 determines a difference between the first value and the second value. Also or alternatively, the analysis circuitry 408 compares the first value and the second value in another manner. For example, the analysis circuitry 408 compares phase overlap between two signals. Also or alternatively, the analysis circuitry 408 compares the frequency of two signals.

In the illustrated example of FIG. 7, at block 714, the analysis circuitry 408 determines if the comparison satisfies an outer threshold for the at least one signal. As described above, the outer threshold corresponds a fault in the power electronics circuit 304. Based on (e.g., in response to) the analysis circuitry 408 determining that the comparison does not satisfy the outer threshold for the at least one signal (block 714: NO), at least one of the machine-readable instructions or the operations 700 proceed to block 718. Based on (e.g., in response to) the analysis circuitry 408 determining that the comparison satisfies the outer threshold for the at least one signal (block 714: YES), at least one of the machine-readable instructions or the operations 700 proceed to block 716. At block 716, the analysis circuitry 408 sends an interrupt to processor circuitry, the interrupt to indicate that the outer threshold for the at least one signal has been satisfied.

In the illustrated example of FIG. 7, at block 718, the analysis circuitry 408 determines if the comparison satisfies an inner threshold for the at least one signal. As described above, the inner threshold corresponds to a condition in the power electronics circuit 304 that may develop into a fault without intervention. Based on (e.g., in response to) the analysis circuitry 408 determining that the comparison does not satisfy the inner threshold for the at least one signal (block 718: NO), at least one of the machine-readable instructions or the operations 700 proceed to block 722. Based on (e.g., in response to) the analysis circuitry 408 determining that the comparison satisfies the inner threshold for the at least one signal (block 718: YES), at least one of the machine-readable instructions or the operations 700 proceed to block 720. At block 720, the analysis circuitry 408 sends an interrupt to processor circuitry, the interrupt to indicate that the inner threshold for the at least one signal has been satisfied.

As described above, the processor circuitry to which the analysis circuitry 408 sends an interrupt includes at least one of the processor circuitry 310 or the system control circuitry 308. For example, if the condition or fault corresponding to a satisfied threshold originates in a component that is not at least one of the primary processor circuitry 310_{A} or the redundant processor circuitry 310_{B}, then the analysis circuitry 408 sends the interrupt to the processor circuitry 310. Also, for example, if the condition or fault corresponding to a satisfied threshold originates in at least one of the primary processor circuitry 310_{A} or the redundant processor circuitry 310_{B}, then the analysis circuitry 408 sends the interrupt to the system control circuitry 308.

In the illustrated example of FIG. 7, at block 722, the communication bus interface circuitry 402 determines whether to continue operating. For example, the communication bus interface circuitry 402 determines to continue operating while the waveform processor circuitry 318 is powered. Based on (e.g., in response to) the communication bus interface circuitry 402 determining to continue operating (block 722: YES), at least one of the machine-readable instructions or the operations 700 return to block 702. Based on (e.g., in response to) the communication bus interface circuitry 402 determining not to continue operating (block 722: NO), at least one of the machine-readable instructions or the operations 700 terminate.

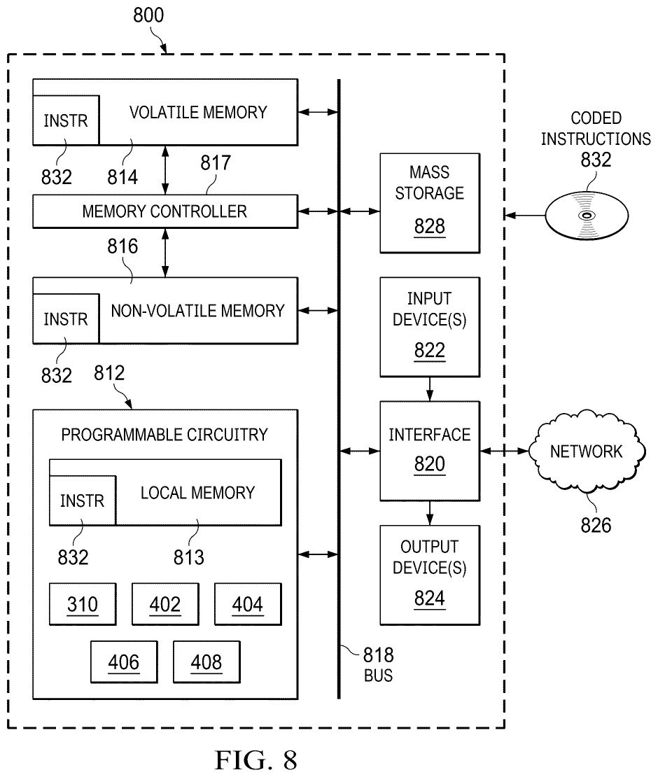

FIG. 8 is a block diagram of an example programmable circuitry platform 800 structured to one or a combination of execute or instantiate one or more of the example machine-readable instructions or the example operations of FIGS. 6 and 7 to implement at least one of the processor circuitry 310 of FIG. 3 or the waveform processor circuitry 318 of FIG. 4. The programmable circuitry platform 800 can be, for example, an electronic control unit of a vehicle, control circuitry for a battery or a motor of a vehicle, or any other type of computing or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, or microcontrollers from any desired family or manufacturer. The programmable circuitry 812 may be implemented by one or more semiconductor based (e.g., silicon based) devices. In this example, the programmable circuitry 812 implements the example processor circuitry 310, the example communication bus interface circuitry 402, the example crossbar circuitry 404, the example measurement circuitry 406, and the example analysis circuitry 408.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 816 may be implemented by one or a combination of flash memory or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter one of or a combination of data or commands into the programmable circuitry 812. The input device(s) 822 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 824 are also connected to the interface circuitry 820 of the illustrated example. The output device(s) 824 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 820 of the illustrated example, thus, includes one of or a combination of a graphics driver card, a graphics driver chip, or graphics processor circuitry such as a GPU.

The interface circuitry 820 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store one or more of firmware, software, or data. Examples of such mass storage discs or devices 828 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 832, which may be implemented by the machine-readable instructions of FIGS. 6 and 7, may be stored in one of or a combination of the mass storage device 828, in the volatile memory 814, in the non-volatile memory 816, or on at least one non-transitory computer-readable storage medium such as a CD or DVD which may be removable.

While an example manner of implementing the waveform processor circuitry 318 is illustrated in FIG. 4, one or more of the elements, processes, or devices illustrated in FIG. 4 may be combined, divided, re-arranged, omitted, eliminated, or implemented in any other way. Further, the example processor circuitry 310, or the example communication bus interface circuitry 402, the example crossbar circuitry 404, the example measurement circuitry 406, the example analysis circuitry 408 or, more generally, the example waveform processor circuitry 318 of FIG. 4, may be implemented by hardware alone or by hardware in combination with software and firmware. Thus, for example, any of the example processor circuitry 310, or the example communication bus interface circuitry 402, the example crossbar circuitry 404, the example measurement circuitry 406, the example analysis circuitry 408 or, more generally, the example waveform processor circuitry 318 of FIG. 4, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example waveform processor circuitry 318 of FIG. 4 may include one or more elements, processes, or devices in addition to, or instead of, those illustrated in FIG. 4, or may include more than one of any or all of the illustrated elements, processes, and devices.

Flowchart(s) representative of example machine-readable instructions, which may be executed by programmable circuitry to at least one of implement or instantiate at least one of the processor circuitry 310 of FIG. 3 or the waveform processor circuitry 318 of FIG. 4 or representative of example operations which may be performed by programmable circuitry to at least one of implement or instantiate at least one of the processor circuitry 310 of FIG. 3 or the waveform processor circuitry 318 of FIG. 4, are shown in FIGS. 6 and 7. The machine-readable instructions may be one or more executable programs or portion(s) of one or more executable programs for execution by programmable circuitry such as the programmable circuitry 812 shown in the example programmable circuitry platform 800 described below in connection with FIG. 8 and may be one or more function(s) or portion(s) of functions to be performed by example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more of at least one non-transitory computer-readable storage medium or at least one non-transitory machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of at least one of the non-transitory computer-readable medium or the non-transitory machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with at least one of a human user or a machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 6 and 7, many other methods of implementing at least one of the example processor circuitry 310 or the example waveform processor circuitry 318 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete analog circuitry, discrete digital circuitry, integrated analog circuitry, integrated digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine-executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to render them directly readable, interpretable, or executable by a computing device or other machine. For example, the machine-readable instructions may be stored in multiple parts, which are individually compressed, encrypted, or stored on separate computing devices, where the parts when decrypted, decompressed, or combined form a set of one or more computer-executable or machine-executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer-readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6 and 7 may be implemented using executable instructions (e.g., at least one of computer-readable instructions or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer-readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer-readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer-readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein “real-time” refers to occurrence in a near instantaneous manner recognizing there may be real world delays for computing time, transmission, etc. Thus, unless otherwise specified, “real-time” refers to real time+1 second.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as at least one of voltage sources or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description.

Modifications are possible in the described examples, and other examples are possible, within the scope of the claims.

From the foregoing, it will be appreciated that example systems, apparatus, articles of manufacture, and methods have been described that allow for diverse or divergent components (e.g., CPUs, ADCs, PWM actuators, etc.) and software (e.g., different algorithms) to be utilized in a safety monitoring system. Also by allowing for diverse or divergent components, examples described herein can utilize diverse tools (e.g., different CPU compilers, different integrated development environments (IDEs), etc.). As such, examples described herein increase safety integrity (e.g., by detecting at least CCFs and increasing a related failure mode effect analysis (FMEA) score). Also, examples described herein perform reliable monitoring that does not result in false positives (e.g., by utilizing a tuned margin of variation). Examples described herein are also flexible, providing a variety of monitoring types and supporting any type of power electronics controller. Examples described herein also eliminate noise in safety monitoring by at least one of averaging values or selecting a peak value for comparison.

Described systems, apparatus, articles of manufacture, and methods improve the efficiency of using a computing device by fully automating monitoring in hardware. As such, examples described herein reduce the amount of MIPS to perform monitoring for safety (e.g., between 10-20%). Also, by implementing example waveform processor circuitry in hardware, examples described herein save cost (e.g., by avoiding at least one of custom CPLD or custom FPGA implementations to compensate for latency critical signal paths). Furthermore, examples described herein consume less area on a chip that other approaches. Described systems, apparatus, articles of manufacture, and methods are also directed to one or more improvement(s) in the operation of a machine such as a computer or other electronic, electromechanical, or mechanical device.

What is claimed is:

1. A system comprising:
a component configured to generate a signal associated with a power electronics circuit; and
a hardware processor circuit coupled to the component, wherein the hardware processor circuit is configured to:
measure, based on a configuration programmed by one or more programmable processor circuits, the signal over an amount of time to generate a first value, the configuration based on a model of the power electronics circuit; and
based on a comparison between the first value and a second value satisfying at least one threshold, generate an interrupt associated with the power electronics circuit.

2. The system of claim 1, wherein the component is a primary component, the signal is a primary signal, the system further comprises a redundant component configured to generate a redundant signal, the hardware processor circuit is coupled to the redundant component, and the hardware processor circuit is configured to:
measure, based on the configuration, the redundant signal over the amount of time to generate the second value; and
determine a difference between the first value and the second value to determine the comparison.

3. The system of claim 1, wherein the second value is based on the configuration programmed by the one or more programmable processor circuits.

4. The system of claim 1, wherein the at least one threshold includes an inner threshold corresponding to a condition in the power electronics circuit that may develop into a fault without intervention, and the interrupt indicates that the inner threshold has been satisfied.

5. The system of claim 1, wherein the at least one threshold includes an outer threshold corresponding to a fault in the power electronics circuit, and the interrupt indicates that the outer threshold has been satisfied.

6. The system of claim 1, wherein the hardware processor circuit is configured to measure the signal based on a trigger event generated by at least one of the one or more programmable processor circuits.

7. The system of claim 1, wherein the hardware processor circuit is to send the interrupt to at least one of the one or more programmable processor circuits or another device.

8. The system of claim 1, wherein the first value includes at least one of an average value of the signal over the amount of time, a peak value of the signal over the amount of time, a phase of the signal over the amount of time, a frequency of the signal over the amount of time, a duty cycle of the signal over the amount of time, or a period of the signal over the amount of time.

9. The system of claim 1, wherein the hardware processor circuit is configured to, based on the configuration, select the signal from two or more signals, the two or more signals associated with the power electronics circuit.

10. The system of claim 1, further comprising one or more programmable processor circuits, the one or more programmable processor circuits coupled to the hardware processor circuit, wherein at least one of the one or more programmable processor circuits is configured to program the configuration for the hardware processor circuit based on the model of the power electronics circuit.

11. A method comprising:
measuring, based on a configuration programmed by one or more programmable processor circuits, a signal over an amount of time to generate a first value, the signal generated by a component associated with a power electronics circuit, the configuration based on a model of the power electronics circuit; and
based on a comparison between the first value and a second value satisfying at least one threshold, generating an interrupt associated with the power electronics circuit.

12. The method of claim 11, wherein the component is a primary component, the signal is a primary signal, and the method further comprises:
measuring, based on the configuration, a redundant signal over the amount of time to generate the second value, the redundant signal generated by a redundant component; and
determine a difference between the first value and the second value to determine the comparison.

13. The method of claim 11, wherein the second value is based on the configuration programmed by the one or more programmable processor circuits.

14. The method of claim 11, wherein:
the at least one threshold includes at least one of (1) an inner threshold corresponding to a condition in the power electronics circuit that may develop into a first fault without intervention or (2) an outer threshold corresponding to a second fault in the power electronics circuit; and
the interrupt indicates that at least one of the inner threshold or the outer threshold has been satisfied.

15. The method of claim 11, wherein the first value includes at least one of an average value of the signal over the amount of time, a peak value of the signal over the amount of time, a phase of the signal over the amount of time, a frequency of the signal over the amount of time, a duty cycle of the signal over the amount of time, or a period of the signal over the amount of time.

16. A system comprising:
a component configured to generate a signal associated with a power electronics circuit;
a hardware processor circuit coupled to the component, wherein the hardware processor circuit is configured to:
measure, based on a configuration, the signal over an amount of time to generate a first value; and
based on a comparison between the first value and a second value satisfying at least one threshold, generate an interrupt associated with the power electronics circuit; and
one or more programmable processor circuits coupled to the hardware processor circuit, wherein at least one of the one or more programmable processor circuits is configured to program the configuration for the hardware processor circuit based on a model of the power electronics circuit.

17. The system of claim 16, wherein the component is a primary component, the signal is a primary signal, the system further comprises a redundant component configured to generate a redundant signal, the hardware processor circuit is coupled to the redundant component, and the hardware processor circuit is configured to:
measure, based on the configuration, the redundant signal over the amount of time to generate the second value; and
determine a difference between the first value and the second value to determine the comparison.

18. The system of claim 16, wherein the second value is based on the configuration programmed by the one or more programmable processor circuits.

19. The system of claim 16, wherein:
the at least one threshold includes at least one of (1) an inner threshold corresponding to a condition in the power electronics circuit that may develop into a first fault without intervention or (2) an outer threshold corresponding to a second fault in the power electronics circuit; and
the interrupt indicates that at least one of the inner threshold or the outer threshold has been satisfied.

20. The system of claim 16, wherein the first value includes at least one of an average value of the signal over the amount of time, a peak value of the signal over the amount of time, a phase of the signal over the amount of time, a frequency of the signal over the amount of time, a duty cycle of the signal over the amount of time, or a period of the signal over the amount of time.
